(19) United States
(12) Patent Application Publication
(10) Pub. No.: US 2010/0311435 A1
(43) Pub. Date: Dec. 9, 2010

(54) BASE STATION SELECTING DEVICES AND METHODS FOR ESTABLISHING COMMUNICATION CONNECTIONS FOR RADIO COMMUNICATION TERMINAL DEVICES

(75) Inventors: Markus Dominik Mueck, Unterhaching (DE); Sabine Van Niekerk, Unterhaching (DE)

Correspondence Address: Viering, Jentschura & Partner, 3770 Highland Ave., Suite 203, Manhattan Beach, CA, 90266, US

(73) Assignee: Infineon Technologies AG, Neubiberg (DE)

(21) Appl. No.: 12/479,891

(22) Filed: Jun. 8, 2009

(51) Int. Cl. H04W 28/08

(52) U.S. Cl. 455/453

(57) ABSTRACT

In an embodiment, a method for establishing a communication connection for a radio communication terminal device in an area that is served by a plurality of base stations is provided. The method may include determining the load situation of each base station of the plurality of base stations; selecting a base station out of the plurality of base stations depending on the load situation of each base station of the plurality of base stations; and establishing a communication connection between the radio communication terminal device and the selected base station. Determining the load situation of each base station of the plurality of base stations may include evaluation of a computational model for the load situation of the respective base station.

### TECHNICAL FIELD

Embodiments relate generally to mobile radio base station selecting devices and methods for establishing communication connections for mobile radio communication terminal devices.

### BACKGROUND

One possible usage of so-called femtocells (which, in a 3GPP (Third Generation Partnership Project) setting are referred to as Home NodeB (HNB) resp. Home eNodeB (eHNB) for the LTE (Long Term Evolution) case) lies in a Campus/Office deployment such that a limited area and/or a specific business area are covered by femtocell access. The inherent advantages of such a deployment include availability of low-cost communication devices, guarantee of quality of service, and, depending on femtocell coverage density, very high throughput serves can be proposed.

In such a scenario, femtocells usually are (at least partially) overlapping and contain all required functionalities such that they can be directly connected to an Internet access (e.g. by Ethernet)—a highly optimized network planning approach avoiding any overlap seems to be unrealistic in a campus/business deployment of femtocells. Moreover, an overlapping approach (with femtocells operating preferably on distinct carrier frequencies) can be deliberately chosen in order to increase the overall system data rate in selected geographic areas.

Furthermore, in any type of wireless communication networks, in order to guarantee seamless coverage of radio communication services, several mobile radio base stations are provided, and accordingly there will probably exist locations where more than one mobile radio base station is available for providing mobile radio communication services to a mobile radio communication terminal device.

Conventionally, the selecting one of multiple femtocells in order to guarantee a certain level of quality of service (QoS), involves the following approach: In order to avoid saturation, conventionally, a femtocell base station (femtocell BS) is only accessible to a small number of users, a so-called “Closed Subscriber Group” (CSG). Such mechanisms are foreseen in UMTS (Universal Mobile Telecommunications System) (by introducing HNBs (Home NodeBs)) and 3GPP LTE (Third Generation Partnership Project Long Term Evolution) (by introducing HeNBs (Home evolved NodeBs)), for example. However, this approach rather targets a single femtocell scenario and does not deal with a solution in which users may choose a femtocell among various possible ones.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1A shows mobile radio communication systems in accordance with an embodiment;

FIG. 1B shows a mobile radio communication system in accordance with an embodiment;

FIG. 2 shows a mobile radio base station selecting device in accordance with an embodiment;

FIG. 3 shows a mobile radio base station selecting device in accordance with an embodiment;

FIG. 4 shows a flow diagram illustrating a method for establishing a communication connection for a mobile radio communication terminal device in an area that is served by a plurality of mobile radio base stations in accordance with an embodiment;

FIG. 5 shows a mobile radio base station selecting device in accordance with an embodiment;

FIG. 6A shows a flow diagram illustrating a method for selecting a mobile radio base station out of a plurality of mobile radio base stations serving a communication terminal for communication with the communication terminal in accordance with an embodiment;

FIG. 6B shows a flow diagram illustrating a method in accordance with an embodiment;

FIG. 7A shows a mobile radio cell state diagram representation in accordance with an embodiment;

FIG. 7B shows a mobile radio cell state diagram representation in accordance with an embodiment;

FIG. 7C shows a mobile radio cell state diagram representation in accordance with an embodiment;

FIG. 8 shows a probability density function representation in accordance with an embodiment;

FIG. 9A shows a mobile radio communication system in accordance with an embodiment;

FIG. 9B shows a flow diagram illustrating a method for selecting a mobile radio base station out of a plurality of mobile radio base stations serving a communication terminal for communication with the communication terminal in accordance with an embodiment;

FIG. 10A shows a mobile radio communication system in accordance with an embodiment;

FIG. 11B shows a flow diagram illustrating a method for selecting a mobile radio base station out of a plurality of mobile radio base stations serving a communication terminal for communication with the communication terminal in accordance with an embodiment;

FIG. 11A shows a mobile radio communication system in accordance with an embodiment;

FIG. 11B shows a flow diagram illustrating a method for selecting a mobile radio base station out of a plurality of mobile radio base stations serving a communication terminal for communication with the communication terminal in accordance with an embodiment; and

FIG. 12 shows a portion of a mobile radio communication system in accordance with an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

The terms “coupling” or “connection” are intended to include a direct “coupling” or direct “connection” as well as an indirect “coupling” or indirect “connection”, respectively.

The term “protocol” is intended to include any piece of software, that is provided to implement part of any layer of the communication definition. “Protocol” may include the functionality of one or more of the following layers: physical layer (layer 1), data link layer (layer 2), network layer (layer 3), or any other sub-layer of the mentioned layers or any upper layer.

Throughout the description, “gateway” and “gateway server” may be used for the same device.

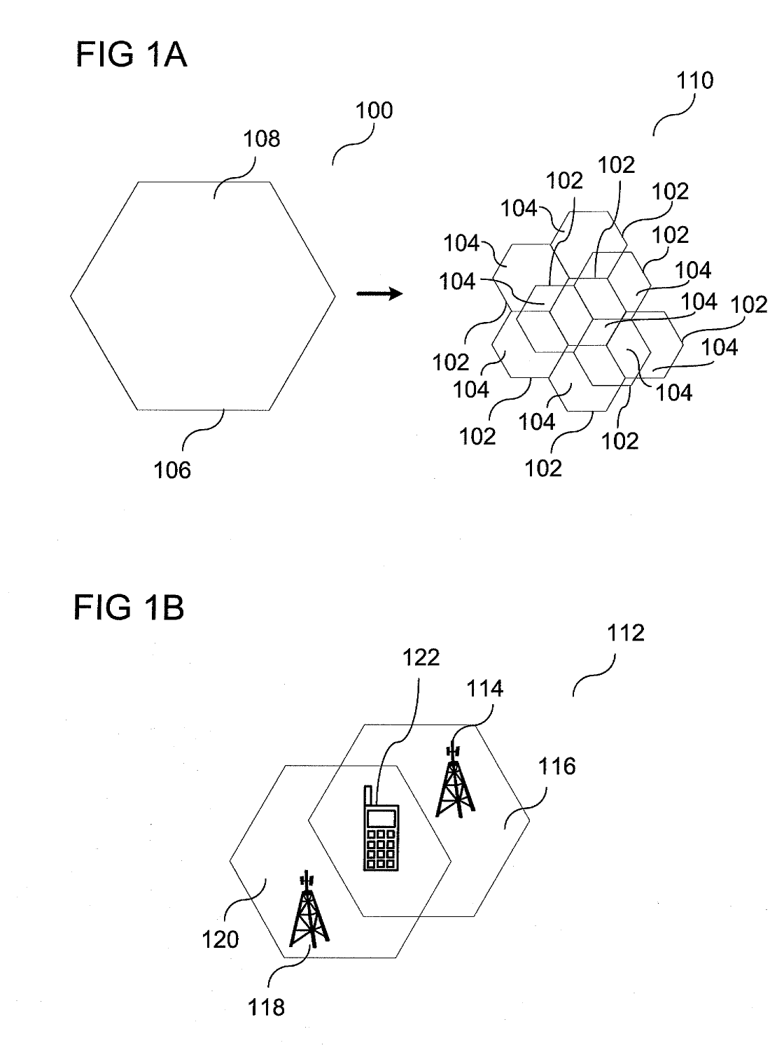

FIG. 1A shows mobile radio communication systems 100 and 110 in accordance with various embodiments. Illustratively, FIG. 1A shows a mobile radio communication system 100, like for example a macro-cell deployment, where one mobile radio base station (not shown) provides coverage of radio communication services inside a specific area 108, thereby forming a mobile radio communication service cell 106. In the mobile radio communication service cell 106, the coverage (in other words: the data-rate that is made available by the mobile radio base station) is not evenly distributed inside the coverage area 108. The coverage (or data-rate) may decrease rapidly with the distance of a mobile radio communication terminal device from the mobile radio base station.

Furthermore, FIG. 1A shows a mobile radio communication system 110, for example femtocells in a business deployment, where several mobile radio base stations (not shown) each provides coverage of mobile radio communication services inside a specific area 104, thereby forming mobile radio communication service femtocells 102. In each mobile radio communication service femtocell 102, the coverage (in other words: the data-rate that is made available by the mobile radio base station) is not evenly distributed inside the coverage area 104. The coverage (or data-rate) decreases with the distance of a mobile radio communication terminal device from the mobile radio base station. However, if the size of each mobile radio communication service femtocell 102 is small compared to the overall coverage area of the sum of the mobile radio base stations, the coverage (and thus the data-rate) may remain good over the whole cell radius due to the small size of the mobile radio communication service femtocells 102. Several mobile radio communication service femtocells 102 may be present to provide coverage in an area that is larger than the coverage area of a single mobile radio communication service femtocell. To ensure seamless coverage even at the boundary areas of a single cell 102, the cells 102 may be arranged in a way to overlap each other. Consequently, there may be locations, where more than one mobile radio base station is available for communication with a mobile radio communication terminal device.

One possible usage of femtocells lies in a campus/office deployment such that a limited area and/or a specific business area are covered by femtocell access. Such a deployment may include i) availability of low-cost communication devices, ii) guarantee of quality of service, iii) depending on femtocell coverage density, very high throughput serves can be proposed.

In such a scenario, femtocells may be (partially) overlapping and may contain all required functionalities such that they may be directly connected to an Internet access (e.g. by Ethernet)—a highly optimized network planning approach avoiding any overlap may be unrealistic in a campus/business deployment of femtocells. Moreover, an overlapping approach (with femtocells base stations operating preferably on distinct carrier frequencies) may be deliberately chosen in order to increase the overall system data rate in selected geographic areas.

With multiple users operating mobile devices in an area where overlapping femtocells exist, the question arises on how to handle the link assignment of the various devices to the femtocell base stations. In this context, various issues should be considered. Depending on the location of the femtocell base stations, some femtocells may be “preferred” by users compared to others, for example due to their location close to a dense working population. Such a “preferred” femtocell may have a higher probability of saturation (i.e., there may be too many users and the requested Quality of Service (QoS) demands may no longer be met). The link selection may be done in such a way that the overall saturation probability is as low as possible. If the mobile radio communication terminal devices are able to select the femtocell base station they wish to connect to, it should be determined which data needs to be communicated to the mobile radio communication terminal devices in order to allow them to do suitable choices. If the mobile radio communication network (NW) determines in a centralized way on which mobile radio communication terminal device may connect to which femtocell base station, it should be determined which data needs to be exchanged between the femtocell base stations and the NW in order to allow a suitable decision. According to an embodiment, data is communicated between femtocell base stations and the NW and/or users in order to allow suitable decisions ensuring a globally minimum (or at least low) saturation probability. According to an embodiment, the usage characteristics of each femtocell base station may be taken into account.

In the macro-cell deployment, the femtocell deployment, and any other mobile radio communication system, where more than one mobile radio base station may provide radio communication services to a mobile radio communication terminal device, there will probably exist locations where more than one mobile radio base station is available for providing mobile radio communication services to a mobile radio communication terminal device at the same time.

FIG. 1B shows a mobile radio communication system 112 in accordance with an embodiment. A first mobile radio base station 114 is configured to provide a first coverage area 116. A second mobile radio base station 118 is configured to provide a second coverage area 120. A mobile radio communication terminal device 122 may be located both in the first coverage area 116 of the first mobile radio base station 114 as well as in the second coverage area 120 of the second mobile radio base station 118. In other words, the mobile radio communication terminal device 122 can communicate with and receive data from and transmit data to the first mobile radio base station 114, and can communicate with and receive data from and transmit data to the second mobile radio base station 118. Although in FIG. 1B two mobile radio base stations 114, 118, are shown, in general, any number of mobile radio base stations which simultaneously provide coverage for a mobile radio communication terminal device may be present.

Various embodiments may deal with the question of to which mobile radio base station a mobile radio communication terminal device should connect, in case that more than one mobile radio base station is potentially available for connection.

In various embodiments, methods and apparatuses may be provided for the efficient assignment of a mobile radio communication terminal device to one among multiple available mobile radio base stations (in other words: mobile radio cells), e.g. femtocell base stations, implicitly assuming that a user is in the coverage area of multiple mobile radio base stations (in other words: cells), e.g. femtocell base stations, with the objective to avoid the saturation of mobile radio base stations (in other words: cells), e.g. femtocell base stations, and to guarantee a high level of user quality of service (QoS).

According to an embodiment, a usage characterization of a mobile radio cell (in other words: of a mobile radio base station, e.g. of a femtocell or a macrocell) is performed, and this usage characterization may then be then exploited to choose a wireless link between the target device (e.g., a femtocell base station) that is characterized by a minimum saturation probability.

In an implementation of the embodiment, the usage characteristics of the mobile radio cell (e.g., the femtocell) may be represented by a computational model, e.g. by a suitable Markov Chain model.

In an embodiment, the saturation probability of mobile radio cells (e.g., of femtocells) may be derived (depending on the usage characters and the current number of users served) as given by a “short term” and “long term” model, as will be described in more detail below.

In an embodiment, a general probability density function approach may be used for characterization of a femtocell and the derivation of the saturation probability, as will be described in more detail below.

In various embodiments, a decision making device (mobile radio base station selecting device) may be provided for the derivation of the most suitable link of a mobile radio communication terminal device to a neighbouring mobile radio base station (in other words: a mobile radio cell), e.g. a femtocell or femtocell base station, assuming that a mobile radio communication terminal device is in the coverage of cells of multiple mobile radio base stations (in other words: of multiple mobile radio cells), e.g. of multiple femtocell base stations. This decision making device (e.g. mobile radio base station selecting device) may be located in the mobile radio communication terminal device, in a mobile radio base station (in other words: in a mobile radio cell), e.g. in a femtocell, or in the mobile radio network (e.g. in a mobile radio cell gateway, e.g. in a femtocell gateway) as will be described in more detail below.

In various embodiments, the most suitable assignment of a radio communication terminal to a mobile radio base station (in other words: to a mobile radio cell), e.g. to a femtocell base station, may be used in order to establish a mobile radio link.

In various embodiments, a suitable modelling approach for quantizing the usage characteristics of a given mobile radio base station (in other words: of a given mobile radio cell), e.g. a femtocell base station, may be provided.

In various embodiments, an approach based on a Markov-Chain model representing a so-called discrete “Discrete Time Birth-Death” model may be provided. The parameters of this Markov model may be obtained by each mobile radio base station (in other words: by each mobile radio cell), e.g. by each femtocell base station, in performing long term observations on its usage characteristics (e.g., how many users are present, which is the probability at a given instant that a user will leave, a new user will enter, etc.).

In various embodiments, data exchange between the mobile radio base stations (in other words: between the mobile radio cells), e.g. between the femtocell base stations, and the mobile radio communication network (NW; e.g. a gateway) and/or a mobile radio communication terminal devices (e.g. a user equipment, UE) may be defined depending on the decision making approach that can either be i) operator-NW centric (i.e. a centralized mobile radio communication NW device may decide on the links of UEs to any specific mobile radio base stations (in other words: to any specific mobile radio cells), e.g. to any specific femtocell base station), ii) mobile radio base stations centric (in other words: cell centric), e.g. femtocell centric, or iii) UE centric (i.e., the UE may obtain usage characteristics of each mobile radio base stations (in other words: of each mobile radio cell), e.g. of each femtocell base station, and consequently may decide on its preferred communication target).

According to various embodiments, a two-fold problem may be addressed:

1) The proposed approach may lead to a highly optimized assignment of UEs to mobile radio base stations (in other words: to mobile radio cells), e.g. to femtocell base stations, in any context where one or multiple UEs may choose among multiple possible links to mobile radio base stations (in other words: to mobile radio cells), e.g. to femtocell base stations;

2) In contrast to conventionally used methods and apparatuses, the link selection efficiently takes the usage characteristics of mobile radio base stations (in other words: of the mobile radio cells), e.g. of the femtocell base stations, into account. Various embodiments may improve the overall assignment of UEs to mobile radio base stations (in other words: to mobile radio cells), e.g. to femtocell base stations, and thus may significantly contribute to the identification of a solution that minimizes the overall saturation probability of the mobile radio base stations (in other words: of the mobile radio cells), e.g. of the femtocell base stations.

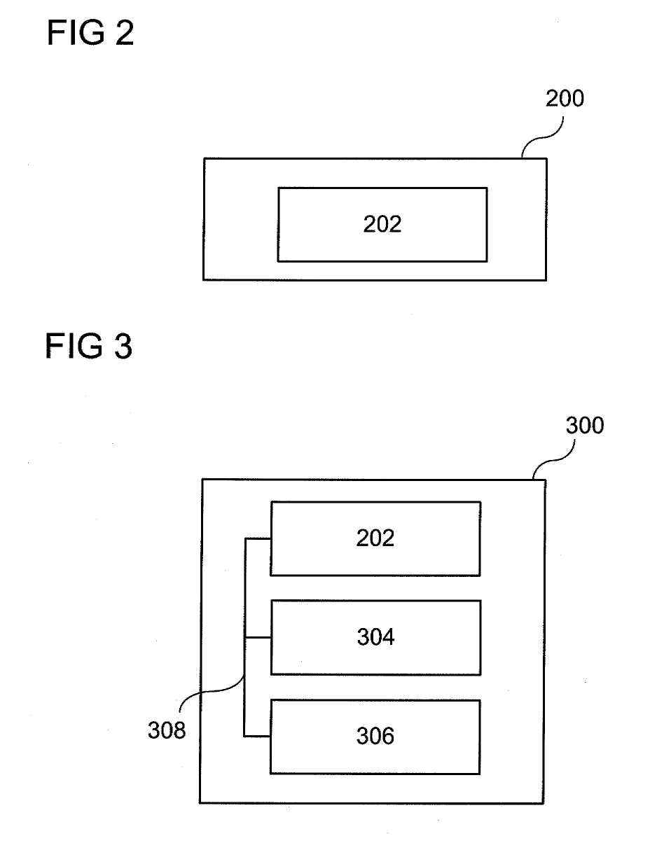

FIG. 2 shows a mobile radio base station selecting device 200 in accordance with an embodiment.

In various embodiments, a mobile radio base station selecting device 200 in a communication system including a plurality of mobile radio base stations and a radio communication terminal in an area that is served by the plurality of mobile radio base stations, may include a mobile radio base station selecting device controller 202 being configured to select a mobile radio base station out of the plurality of mobile radio base stations depending on a load situation of each respective mobile radio base station of the plurality of mobile radio base stations; and to trigger establishment of a communication connection between the mobile radio communication terminal device and the selected mobile radio base station.

In various embodiments, the mobile radio base station selecting device may be configured to be a part of at least one mobile radio base station.

In various embodiments, the mobile radio base station selecting device may be configured to be a part of a radio communication terminal.

In various embodiments, the mobile radio base station selecting device may be configured to be a part of a gateway server.

In various embodiments, the mobile radio base station selecting device may be configured to be a part of a combination of at least one mobile radio base station, a radio communication terminal, and a gateway server.

In various embodiments, the mobile radio base station selecting device may be configured to be located anywhere outside the radio communication terminal and outside the network. In various embodiments, the mobile radio base station selecting device may be configured to be part of an external server, wherein the external server may be located outside the radio communication terminal and outside the network (in other words: external to the radio communication terminal and external to the network).

In various embodiments, each mobile radio base station of the plurality of mobile radio base stations may be configured according to at least one radio communication technology of one of the following radio communication technology families:

a Short Range radio communication technology family;

a Metropolitan Area System radio communication technology family;

a Cellular Wide Area radio communication technology family;

a radio communication technology family which includes a radio communication technology in which the access to radio resources is provided in a random manner; and

a radio communication technology family which includes a radio communication technology in which the access to radio resources is provided in a centrally controlled manner.

In various embodiment, each mobile radio base station of the plurality of mobile radio base stations may be configured according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the mobile radio base station selecting device may be configured to select from base stations configured according to at least two different radio communication technology families.

In various embodiments, the mobile radio base station selecting device may be configured to select from base stations configured according to at least two different radio communication technologies.

In various embodiments, the mobile radio base station selecting device may be configured to select at least two base stations configured according to at least two different radio communication technology families.

In various embodiments, the mobile radio base station selecting device may be configured to select at least two base stations configured according to at least two different radio communication technologies.

In various embodiments, the mobile radio base station selecting device may be configured to select at least two base stations in case the mobile radio base station selecting device determines that one base station alone cannot properly handle the connection requirements of the mobile radio communication terminal.

In various embodiments, if the mobile radio communication terminal requests connection at a requested connection data rate, and the mobile radio base station selecting device determines that one base station alone cannot provide the requested connection data rate (in other words: none of the available base stations alone can provide the requested connection data rate), the mobile radio base station selecting device may select two or more base stations, that together can provide the requested connection data rate.

In various embodiments, each mobile radio base station of the plurality of mobile radio base stations may provide an average coverage radius of about 50 m to 200 m.

In various embodiments, each mobile radio base station of the plurality of mobile radio base stations may provide an average coverage radius of more than one kilometer

In various embodiments, the mobile radio communication terminal device may be configured according to at least one radio communication technology of one of the following radio communication technology families:

a Short Range radio communication technology family;

a Metropolitan Area System radio communication technology family;

a Cellular Wide Area radio communication technology family;

a radio communication technology family which includes a radio communication technology in which the access to radio resources is provided in a random manner; and

a radio communication technology family which includes a radio communication technology in which the access to radio resources is provided in a centrally controlled manner.

In various embodiments, the mobile radio communication terminal device may be configured according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3 GPP LTE (long term Evolution), 3 GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In an implementation of the embodiment, the mobile radio base station selecting device controller 202 may be further configured to determine the load situation of each mobile radio base station of the plurality of mobile radio base stations.

The load situation of each mobile radio base station may be determined based on the level of usage of a at least one available resource of the mobile radio base station selected from a group of resources consisting of a computational resource, a processor, a dedicated hardware circuit, an application-specific integrated circuit, a field-programmable gate array, a software-defined radio circuit, a digital signal processor, a memory circuit, a radio interface circuit, a cable connection circuit, an asymmetric digital subscriber line circuit, a battery, an output power limitation circuit, a power budget circuit, and an antenna.

The load situation of each mobile radio base station may be determined based on the number of connections at the respective mobile radio base station.

The load situation of each mobile radio base station may be determined based on the amount of data at least one of received at and transmitted from the respective mobile radio base station.

The load situation of each mobile radio base station may be determined based on the data rate of data reception at the respective mobile radio base station.

The load situation of each mobile radio base station may be determined based on the data rate of data transmission from the respective mobile radio base station.

The load situation of each mobile radio base station may be determined based on the data rate of data reception and data transmission at and from the respective mobile radio base station.

The load situation of each mobile radio base station may be determined based on the current load situation of the respective mobile radio base station. In other words: the current load situation at each of the mobile radio base stations may be considered.

The load situation of each mobile radio base station may be determined based on the load situation of the respective mobile radio base station accumulated during pre-defined time intervals.

The time intervals may be chosen based on the predefined day of the week.

The pre-defined day of the week may be the current day of the week.

The time intervals may be chosen based on a predefined time instant.

The predefined time instant may be the current time instant.

The time intervals may be chosen so as to contain at least the same time of the day of at least one previous day as the current time.

The time intervals may be chosen so as to contain at least the previous time interval before the current time of a pre-defined length.

The time intervals may be chosen to be independent of the current time.

FIG. 3 shows a mobile radio base station selecting device 300 in accordance with an embodiment.

In various embodiments, a mobile radio base station selecting device 300 in a communication system including a plurality of mobile radio base stations and a radio communication terminal in an area that is served by the plurality of mobile radio base stations, besides a mobile radio base station selecting device controller 202 like described with reference to FIG. 2, may further include a model evaluator 304 configured to evaluate a computational model for the load situation of mobile radio base stations for determining the load situation of each mobile radio base station of the plurality of mobile radio base stations and a measurement device 306 configured to measure the load situation at predefined points of time.

In various embodiments, the parameters of the computational model may be determined based on solving a nonlinear optimization problem, where data about the load situation history (in other words: the usage characteristics) of the respective mobile radio base station may be considered, and a nonlinear optimization problem may be solved to achieve a possibly high agreement between the computational model and the real load situation.

The mobile radio base station selecting device controller 202, the model evaluator 304, and the measurement device 306 may be coupled with each other, e.g. via an electrical connection 308 such as e.g. a cable or a computer bus or via any other suitable electrical connection to exchange electrical signals.

In an implementation of the embodiment, the model evaluator 304 may be configured to evaluate an adaptive computational model. The model evaluator 304 may be configured to adapt the structure or parameters of the adaptive computational model according to the current situation at the respective mobile radio base station.

The model evaluator 304 may be configured to evaluate a static computational model. The static computational model may be a fixed computational model with respect to time and change of the current situation at the respective mobile radio base station. It may be set up once in advance, or it may be updated automatically or by an operator at pre-defined times.

The model evaluator 304 may be configured to evaluate a time variant computational model. The time variant computational model may depend on the current system time of the respective mobile radio base station.

The model evaluator 304 may be configured to evaluate a Markov-type model. The situation at the respective mobile radio base station may be described by discrete states, as will be described below in more detail.

The mobile radio base station selecting device controller may be configured to determine the load situation of each mobile radio base station based on a probability density function describing relation between the probability of saturation and the number of users of a base station. Based on observations of the situation of each respective mobile radio base station in the past, a probability density function may be constructed, as will be described below in more detail.

The model evaluator 304 may be configured to evaluate an optimum filter, e.g. a Kalman filter. (Differential) equations describing the behaviour of the situation at each respective mobile radio base station may be set up, and parameters may be determined, e.g. by nonlinear parameter optimization methods, to achieve a good agreement between real behavior and the behavior modeled by the equations.

The model evaluator 304 may be configured to evaluate a neural network type model. The neural network may be trained based on collected data about the load situation history (in other words: the usage characteristics) of the respective mobile radio base station.

The mobile radio base station selecting device controller may be configured to determine the load situation of each mobile radio base station based on a statistic optimization method optimizing parameters of parameterized functions for describing relation between the probability of saturation and the number of users of a base station.

The mobile radio base station selecting device controller may be configured to determine the load situation of each mobile radio base station based on a Maximum Likelihood type method estimating the relation between the probability of saturation and the number of users of a base station.

The mobile radio base station selecting device controller may be configured to determine the load situation of each mobile radio base station based on a random walk type method estimating the relation between the probability of saturation and the number of users of a base station.

In an implementation of the embodiment, the mobile radio base station selecting device controller may be further configured to determine the load situation of each mobile radio base station based on the current load situation of the respective mobile radio base station accumulated during pre-defined time intervals, and to determine the load situation based on the average load over the time intervals.

In various embodiments, the mobile radio base station selecting device controller may be configured to determine the load situation by evaluation of the computational model.

The model evaluator 304 may be configured to evaluate the computational model analytically.

The model evaluator 304 may be configured to evaluate the computational model numerically.

The model evaluator 304 may be configured to evaluate the computational model by Monte Carol type simulation.

The model evaluator 304 may be configured to evaluate the computational model to predict the load situation for the future.

The model evaluator 304 may be configured to evaluate the computational model to predict the load situation for a predefined period of time in the future.

Information about the pre-defined period of time may be collected from the user of the mobile radio communication terminal device.

The model evaluator 304 may be configured to evaluate the computational model to predict the load situation for a pre-defined amount of data to be received and or transmitted at and/or from the mobile radio base station.

Information about the pre-defined amount of data may be collected from the user of the mobile radio communication terminal device.

The mobile radio base station selecting device controller 202 may be configured to determine for each mobile radio base station a load situation rating number quantifying the load situation of the respective mobile radio base station.

The mobile radio base station selecting device controller 202 may be configured to compute a load situation rating number to quantify a percentage for recommended use of the respective mobile radio base station.

The mobile radio base station selecting device controller 202 may be configured to compute a load situation rating number to quantify a period of time from the current time during which the probability of saturation of the mobile radio base station is below a predefined saturation probability.

The user of the mobile radio communication terminal device may set the pre-defined saturation probability.

The user of the mobile radio communication terminal device may set the predefined saturation probability as a fixed preference.

The user of the mobile radio communication terminal device may set the predefined saturation probability for each connection request separately.

The mobile radio base station selecting device controller 202 may be configured to compute a load situation rating number to quantify a pre-defined amount of data that can be received at the mobile radio base station from the radio communication terminal so that during reception of the data the probability of saturation of the mobile radio base station is below a predefined saturation probability.

The user of the mobile radio communication terminal device may set the predefined saturation probability.

The user of the mobile radio communication terminal device may set the predefined saturation probability as a fixed preference.

The user of the mobile radio communication terminal device may set the predefined saturation probability for each connection request separately.

The mobile radio base station selecting device controller 202 may be configured to compute a load situation rating number to quantify a pre-defined amount of data that can be sent from the mobile radio base station to the mobile radio communication terminal device so that during sending of the data the probability of saturation of the mobile radio base station is below a predefined saturation probability.

The user of the mobile radio communication terminal device may set the predefined saturation probability.

The user of the mobile radio communication terminal device may set the predefined saturation probability as a fixed preference.

The user of the mobile radio communication terminal device may set the predefined saturation probability for each connection request separately.

In various embodiments, a combination of an amount of data that can be received at the mobile radio base station and of an amount of data that can be transmitted from the mobile radio base station may be considered instead of considering only an amount of data that can be received or an amount of data the can be sent.

The mobile radio base station selecting device controller 202 may be configured to compute a load situation rating number to quantify the probability of non-saturation of the mobile radio base station during a predefined period of time from the current time.

The user of the mobile radio communication terminal device may set the predefined period of time.

The user of the mobile radio communication terminal device may set the predefined period of time as a fixed preference.

The user of the mobile radio communication terminal device may set the predefined period of time for each connection request separately.

The mobile radio base station selecting device controller 202 may be configured to compute a load situation rating number to quantify the probability of non-saturation of the mobile radio base station during the reception of a predefined amount of data at the mobile radio base station from the mobile radio communication terminal device.

The user of the mobile radio communication terminal device may set the predefined amount of data.

The user of the mobile radio communication terminal device may set the predefined amount of data as a fixed preference.

The user of the radio communication terminal may set the predefined amount of data for each connection request separately.

The mobile radio base station selecting device controller 202 may be configured to compute a load situation rating number to quantify the probability of saturation of the mobile radio base station during the transmission of a predefined amount of data from the mobile radio base station to the mobile radio communication terminal device.

The user of the mobile radio communication terminal device may set the predefined amount of data.

The user of the mobile radio communication terminal device may set the predefined amount of data as a fixed preference.

The user of the mobile radio communication terminal device may set the predefined amount of data for each connection request separately.

In various embodiments, a combination of an amount of data that can be received at the mobile radio base station and of an amount of data that can be transmitted from the mobile radio base station may be considered instead of considering only an amount of data that can be received or an amount of data the can be sent.

The mobile radio base station selecting device 300 may be configured to collect information about the load situation for each mobile radio base station and to acquire the load situation rating number based on the collected information about the load situation.

The measurement device 306 may be configured to measure the load situation at predefined points of time. The measurement device 306 may further be configured to use these measurements as information about the load situation.

The mobile radio base station selecting device 300 may be configured to use the information about the load situation as parameters for the computational model.

The mobile radio base station selecting device 300 may be configured to use the information about the load situation as the load situation rating number.

The mobile radio base station selecting device 300 may be configured to select a mobile radio base station with the highest load situation rating number.

The mobile radio base station selecting device 300 may be configured to select the mobile radio base station with the highest load situation rating number and with the best reception properties at the mobile radio communication terminal device if more than one mobile radio base station with the highest load situation rating number is present.

The mobile radio base station selecting device 300 may be configured to determine the reception properties based on the signal-to-noise ratio.

The mobile radio base station selecting device 300 may be configured to select a mobile radio base station with a load situation rating number above a pre-defined threshold.

The user of the mobile radio communication terminal device may set the pre-defined threshold.

The user of the mobile radio communication terminal device may set the pre-defined threshold as a fixed preference.

The user of the mobile radio communication terminal device may set the pre-defined threshold for each connection request separately.

The mobile radio base station selecting device 300 may be configured to select the mobile radio base station with a load situation rating number above the pre-defined threshold and with the best reception properties at the mobile radio communication terminal device in case more than one mobile radio base station with a load situation rating number above the pre-defined threshold is present.

The mobile radio base station selecting device 300 may be configured to determine the reception properties based on the signal-to-noise ratio.

The mobile radio base station selecting device 300 may be configured to perform the selection repeatedly, and in case that the selected mobile radio base station is different from the mobile radio base station currently connected with the mobile radio communication terminal device, to establish a communication connection between the mobile radio communication terminal device and the selected mobile radio base station.

Each mobile radio base station of a plurality of mobile radio base stations may transmit information about the load situation at the respective mobile radio base station to a load information collector.

Each mobile radio base station of a plurality of mobile radio base stations may transmit information about the load situation at the respective mobile radio base station to a load information collector in a mobile radio base station.

The load information collector may be included in the mobile radio base station selecting device 300.

Each mobile radio base station of a plurality of mobile radio base stations may transmit information about the load situation at the respective mobile radio base station to the gateway server including the mobile radio base station selecting device 300.

Each mobile radio base station of a plurality of mobile radio base stations may transmit information about the load situation at the respective mobile radio base station to the mobile radio communication terminal device including the mobile radio base station selecting device 300.

The mobile radio communication terminal device may request the information about the load situation from the respective mobile radio base stations.

The load information collector may be configured to transmit the information about the load situation of each mobile radio base station of the plurality of mobile radio base stations to the mobile radio communication terminal device.

The mobile radio communication terminal device may be configured to request the information about the load situation from the load information collector.

The radio communication mobile radio communication terminal device may be configured to receive the information about the load situation from a mobile radio base station together with a location registration message.

The mobile radio communication terminal device may be configured to receive the information about the load situation from a mobile radio base station together with a neighboring cell list.

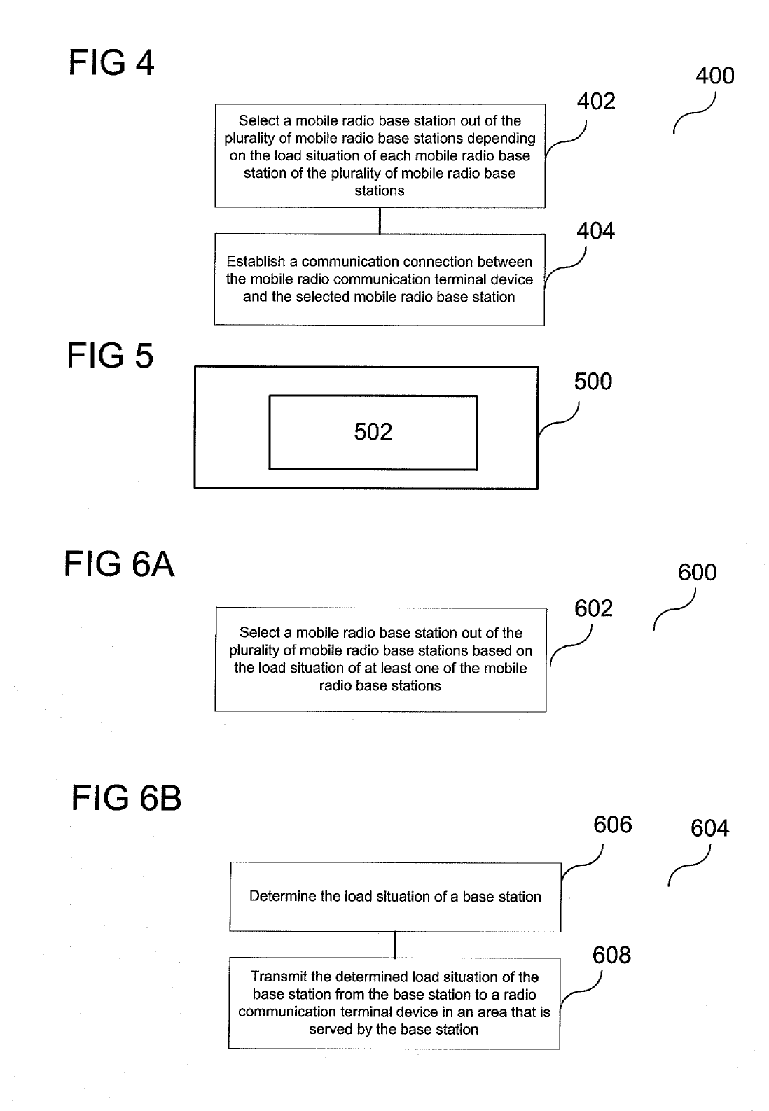

FIG. 4 shows a flow diagram 400 illustrating a method for establishing a communication connection for a mobile radio communication terminal device in an area that is served by a plurality of mobile radio base stations in accordance with an embodiment. The method may include, in 402, selecting a mobile radio base station out of the plurality of mobile radio base stations depending on the load situation of each mobile radio base station of the plurality of mobile radio base stations, and, in 404, establishing a communication connection between the mobile radio communication terminal device and the selected mobile radio base station.

In various embodiments, each mobile radio base station of the plurality of mobile radio base stations may be configured according to at least one of the following radio communication technology of one of the following radio communication technology families:

a Short Range radio communication technology family;

a Metropolitan Area System radio communication technology family;

a Cellular Wide Area radio communication technology family;

a radio communication technology family which includes a radio communication technology in which the access to radio resources is provided in a random manner; and

a radio communication technology family which includes a radio communication technology in which the access to radio resources is provided in a centrally controlled manner.

In various embodiments, each mobile radio base station of the plurality of mobile radio base stations may be configured according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the mobile radio base station selecting device may be configured to select from base stations configured according to at least two different radio communication technology families.

In various embodiments, the mobile radio base station selecting device may be configured to select from base stations configured according to at least two different radio communication technologies.

In various embodiments, the mobile radio base station selecting device may be configured to select at least two base stations configured according to at least two different radio communication technology families.

In various embodiments, the mobile radio base station selecting device may be configured to select at least two base stations configured according to at least two different radio communication technologies.

In various embodiments, the mobile radio base station selecting device may be configured to select at least two base stations in case the mobile radio base station selecting device determines that one base station alone cannot properly handle the connection requirements of the mobile radio communication terminal.

In various embodiments, if the mobile radio communication terminal requests connection at a requested connection data rate, and the mobile radio base station selecting device determines that one base station alone cannot provide the requested connection data rate (in other words: none of the available base stations alone can provide the requested connection data rate), the mobile radio base station selecting device may select two or more base stations, that together can provide the requested connection data rate.

In various embodiments, each mobile radio base station of the plurality of mobile radio base stations may provide an average coverage radius of about 50 m to 200 m.

In various embodiments, each mobile radio base station of the plurality of mobile radio base stations may provide an average coverage radius of more than one kilometer.

In various embodiments, the mobile radio communication terminal device may be configured according to at least one radio communication technology of one of the following radio communication technology families:

a Short Range radio communication technology family;

a Metropolitan Area System radio communication technology family;

a Cellular Wide Area radio communication technology family;

a radio communication technology family which includes a radio communication technology in which the access to radio resources is provided in a random manner; and

a radio communication technology family which includes a radio communication technology in which the access to radio resources is provided in a centrally controlled manner.

In various embodiments, the mobile radio communication terminal device may be configured according to at least one of the following radio communication technologies: a Bluetooth radio communication technology, an Ultra Wide Band (UWB) radio communication technology, a Wireless Local Area Network radio communication technology (e.g. according to an IEEE 802.11 (e.g. IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), a Worldwide Interoperability for Microwave Access (WiMax) (e.g. according to an IEEE 802.16 radio communication standard, e.g. WiMax fixed or WiMax mobile), WiPro, HiperMAN (High Performance Radio Metropolitan Area Network), IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (long term Evolution), 3GPP LTE Advanced (long term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System-Time-Division Duplex), TD-CDMA (Time Division-Code Division Multiple Access), TD-CDMA (Time Division-Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (long term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, and Unlicensed Mobile Access (UMA, also referred to as also referred to as 3GPP Generic Access Network, or GAN standard)).

In various embodiments, the method may further include determining the load situation of each mobile radio base station of the plurality of mobile radio base stations.

The load situation of each mobile radio base station may be determined based on the level of usage of a at least one available resource of the mobile radio base station selected from a group of resources consisting of a computational resource, a processor, a dedicated hardware circuit, an application-specific integrated circuit, a field-programmable gate array, a software-defined radio circuit, a digital signal processor, a memory circuit, a radio interface circuit, a cable connection circuit, an asymmetric digital subscriber line circuit, a battery, an output power limitation circuit, a power budget circuit, and an antenna.

The load situation of each mobile radio base station may be determined based on a number of connections at the respective mobile radio base station.

The load situation of each mobile radio base station may be determined based on an amount of data at least one of received at and transmitted from the respective mobile radio base station.

The load situation of each mobile radio base station may be determined based on a data rate of data reception at the respective mobile radio base station.

The load situation of each mobile radio base station may be determined based on a data rate of data transmission from the respective mobile radio base station.

The load situation of each mobile radio base station may be determined based on a data rate of data reception and/or data transmission at and/or from the respective mobile radio base station.

The load situation of each mobile radio base station may be determined based on a current load situation of the respective mobile radio base station.

The load situation of each mobile radio base station may be determined based on a load situation of the respective mobile radio base station accumulated during pre-defined time intervals in the past.

The time intervals may be chosen based on a predefined day of the week. The pre-defined day of the week may be the current day of the week.

The time intervals may be chosen based on a predefined time instant. The predefined time instant may be the current time instant.

The time intervals may be chosen so as to contain at least the same time of the day of at least one previous day as the current time.

The time intervals may be chosen so as to contain at least the previous time interval before the current time of a pre-defined length.

The time intervals may be chosen to be independent of the current time.

In an implementation of the embodiment, determining the load situation of each mobile radio base station of the plurality of mobile radio base stations may include evaluating a computational model for the load situation of the respective mobile radio base station.

The computational model may be an adaptive computational model. The computational model may be adapted to the structure or parameters of the adaptive computational model according to the current situation at the respective mobile radio base station.

The computational model may be a static computational model. The static computational model may be a fixed computational model with respect to time and change of the current situation at the respective mobile radio base station. It may be set up once in advance, or it may be updated automatically or by an operator at pre-defined times.

The computational model may be a time variant computational model. The time variant computational model may depend on the current system time of the respective mobile radio base station.

The load situation of each mobile radio base station may be determined based on the current load situation of the respective mobile radio base station accumulated during pre-defined time intervals, and the load situation may be determined based on the average load over the pre-defined time intervals.

The computational model may be a Markov-type model. The situation at the respective mobile radio base station may be described by discrete states, as will be described below in more detail.

The toad situation may be determined based on a probability density function describing relation between the probability of saturation and the number of users of a base station. Based on observations of the situation of each respective mobile radio base station in the past, a probability density function may be constructed, as will be described below in more detail.

The computational model may be an optimum filter, e.g. a Kalman filter. (Differential) equations describing the behaviour of the situation at each respective mobile radio base station may be set up, and parameters may be determined, e.g. by nonlinear parameter optimization methods, to achieve a good agreement between real behavior and the behavior modeled by the equations.

The computational model may be a neural network type computational model. The neural network may be trained based on collected data about the load situation history (in other words: the usage characteristics) of the respective mobile radio base station.

The load situation may be determined based on a statistic optimization method optimizing parameters of parameterized functions for describing relation between the probability of saturation and the number of users of a base station.

The load situation may be determined based on a Maximum Likelihood type method estimating the relation between the probability of saturation and the number of users of a base station.

The load situation may be determined based on a random walk type method estimating the relation between the probability of saturation and the number of users of a base station.

In various embodiments, the load situation may be determined by evaluation of the computational model.

The computational model may be evaluated analytically.

The computational model may be evaluated numerically.

The computational model may be evaluated by Monte Carol type simulation.

The computational model may be evaluated to predict the load situation.

The computational model may be evaluated to predict the load situation for a predefined period of time in the future.

Information about the pre-defined period of time may be collected from the user of the mobile radio communication terminal device.

The computational model may be evaluated to predict the load situation for a pre-defined amount of data to be received at the mobile radio base station.

Information about the pre-defined amount of data may be collected from the user of the mobile radio communication terminal device.

For each mobile radio base station a load situation rating number quantifying the load situation of the respective mobile radio base station may be computed.

A load situation rating number may be computed to quantify a percentage for recommended use of the respective mobile radio base station.

A load situation rating number may be computed to quantify a period of time from the current time during which the probability of saturation of the mobile radio base station is below a predefined saturation probability.

The user of the mobile radio communication terminal device may set the pre-defined saturation probability.

The user of the mobile radio communication terminal device may set the predefined saturation probability as a fixed preference.

The user of the mobile radio communication terminal device may set the predefined saturation probability for each connection request separately.

In an implementation of the embodiment, a load situation rating number may be computed to quantify a pre-defined amount of data that can be received at the mobile radio base station from the radio communication terminal so that during reception of the data the probability of saturation of the mobile radio base station is below a predefined saturation probability.

The user of the mobile radio communication terminal device may set the predefined saturation probability.

The user of the mobile radio communication terminal device may set the predefined saturation probability as a fixed preference.

The user of the mobile radio communication terminal device may set the predefined saturation probability for each connection request separately.

A load situation rating number may be computed to quantify a pre-defined amount of data that can be sent from the mobile radio base station to the mobile radio communication terminal device so that during sending of the data the probability of saturation of the mobile radio base station is below a predefined saturation probability.

The user of the mobile radio communication terminal device may set the predefined saturation probability.

The user of the mobile radio communication terminal device may set the predefined saturation probability as a fixed preference.

The user of the mobile radio communication terminal device may set the predefined saturation probability for each connection request separately.

In various embodiments, a combination of an amount of data that can be received at the mobile radio base station and of an amount of data that can be transmitted from the mobile radio base station may be considered instead of considering only an amount of data that can be received or an amount of data the can be sent.

A load situation rating number may be computed to quantify the probability of non-saturation of the mobile radio base station during a predefined period of time from the current time.

The user of the mobile radio communication terminal device may set the predefined period of time.

The user of the mobile radio communication terminal device may set the predefined period of time as a fixed preference.

The user of the mobile radio communication terminal device may set the predefined period of time for each connection request separately.

A load situation rating number may be computed to quantify the probability of non-saturation of the mobile radio base station during the reception of a predefined amount of data at the mobile radio base station from the mobile radio communication terminal device.

The user of the mobile radio communication terminal device may set the predefined amount of data.

The user of the mobile radio communication terminal device may set the predefined amount of data as a fixed preference.

The user of the mobile radio communication terminal device may set the predefined amount of data for each connection request separately.

A load situation rating number may be computed to quantify the probability of saturation of the mobile radio base station during the transmission of a predefined amount of data from the mobile radio base station to the mobile radio communication terminal device.

The user of the mobile radio communication terminal device may set the predefined amount of data.

The user of the mobile radio communication terminal device may set the predefined amount of data as a fixed preference.

The user of the mobile radio communication terminal device may set the predefined amount of data for each connection request separately.

In various embodiments, a combination of an amount of data that can be received at the mobile radio base station and of an amount of data that can be transmitted from the mobile radio base station may be considered instead of considering only an amount of data that can be received or an amount of data the can be sent.

In various embodiments, the method may further include for each mobile radio base station collecting information about the load situation; and acquiring the load situation rating number based on the collected information about the load situation.

The method may further include measuring the load situation at predefined points of time. These measurements may be used as information about the load situation.

The information about the load situation may be parameters for the computational model.

The information about the load situation may be the load situation rating number.

In various embodiments, a mobile radio base station with the highest load situation rating number may be selected.

If more than one mobile radio base station with the highest load situation rating number is present, the mobile radio base station with the highest load situation rating number and with the best reception properties at the mobile radio communication terminal device may be selected.

The reception properties may be determined based on the signal-to-noise ratio.

In various embodiments, a mobile radio base station with a load situation rating number above a pre-defined threshold may be selected.

The user of the mobile radio communication terminal device may set the pre-defined threshold.

The user of the mobile radio communication terminal device may set the pre-defined threshold as a fixed preference.

The user of the mobile radio communication terminal device may set the pre-defined threshold for each connection request separately.

In case more than one mobile radio base station with a load situation rating number above the pre-defined threshold is present, the mobile radio base station with a load situation rating number above the pre-defined threshold and with the best reception properties at the mobile radio communication terminal device may be selected.

The reception properties may be determined based on the signal-to-noise ratio.

In an implementation of the embodiment, the selection may be performed repeatedly, and in case that the selected mobile radio base station is different from the mobile radio base station currently connected with the mobile radio communication terminal device, a radio communication connection between the mobile radio communication terminal device and the selected mobile radio base station may be established.

Each mobile radio base station of a plurality of mobile radio base stations may transmit information about the load situation at the respective mobile radio base station to a load information collector.

Each mobile radio base station of a plurality of mobile radio base stations may transmit information about the load situation at the respective mobile radio base station to a load information collector in a mobile radio base station.

The selection may be performed by a mobile radio base station out of the plurality of mobile radio base stations.

Each mobile radio base station of a plurality of mobile radio base stations may transmit information about the load situation at the respective mobile radio base station to the mobile radio base station performing the selection.

The load information collector may transmit the information about the load situation of each mobile radio base station of the plurality of mobile radio base stations to the mobile radio base station performing the selection.

The selection may be performed by a gateway server connecting serving a plurality of mobile radio base stations.

Each mobile radio base station of a plurality of mobile radio base stations may transmit information about the load situation at the respective mobile radio base station to the gateway server performing the selection.

The load information collector may transmit the information about the load situation of each mobile radio base station of the plurality of mobile radio base stations to the gateway server performing the selection.

The selection may be performed by the mobile radio communication terminal device.

Each mobile radio base station of a plurality of mobile radio base stations may transmit information about the load situation at the respective mobile radio base station to the mobile radio communication terminal device.

The mobile radio communication terminal device may request the information about the load situation from the respective mobile radio base stations.

The load information collector may transmit the information about the load situation of each mobile radio base station of the plurality of mobile radio base stations to the mobile radio communication terminal device.

The mobile radio communication terminal device may request the information about the load situation from the load information collector.

The mobile radio communication terminal device may receive the information about the load situation from a mobile radio base station together with a location registration message.

The mobile radio communication terminal device may receive the information about the load situation from a mobile radio base station together with a neighboring cell list.

FIG. 5 shows a mobile radio base station selecting device 500 in accordance with an embodiment. The mobile radio base station selecting device 500 for selecting a mobile radio base station out of a plurality of mobile radio base stations serving a communication terminal for communication with the communication terminal may include a mobile radio base station selecting device controller 502 configured to select a mobile radio base station out of the plurality of mobile radio base stations based on the load situation of at least one of the mobile radio base stations.

FIG. 6A shows a flow diagram 600 illustrating a method for selecting a mobile radio base station out of a plurality of mobile radio base stations serving a mobile radio communication terminal device for communication with the mobile radio communication terminal device in accordance with an embodiment. The method may include, in 602, selecting a mobile radio base station out of the plurality of mobile radio base stations based on the load situation of at least one of the mobile radio base stations.

FIG. 6B shows a flow diagram 604 illustrating a method in accordance with an embodiment. The method may include, in 606, determining the load situation of a mobile radio base station; and, in 608, transmitting the determined load situation of the mobile radio base station from the mobile radio base station to a mobile radio communication terminal device in an area that is served by the mobile radio base station. In various embodiments, in 606, the load situation may be determined according in the various ways described above and below.

In various embodiments, an apparatus may be provided in accordance with an embodiment. In various embodiments, the apparatus may include a circuit configured to determine the load situation of a mobile radio base station; and a circuit configured to transmit the determined load situation of the mobile radio base station from the mobile radio base station to a mobile radio communication terminal device in an area that is served by the mobile radio base station. In various embodiments, the load situation may be determined according in the various ways described above and below.

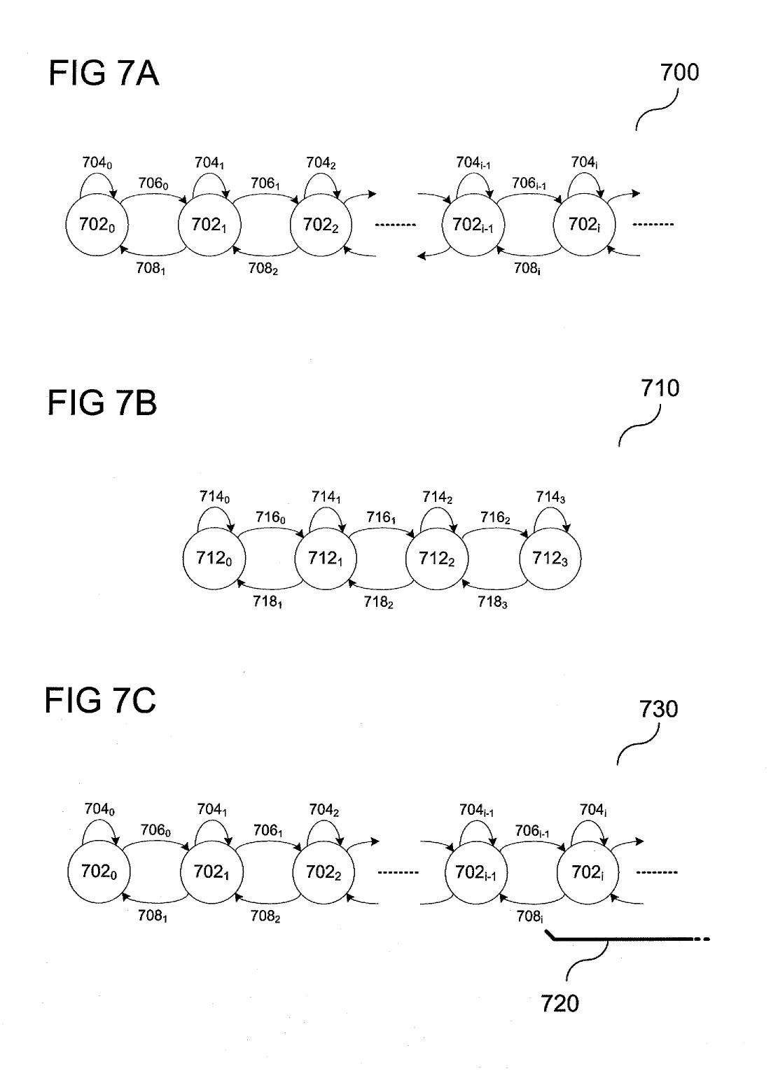

In various embodiments, a “Discrete Time Birth-Death” model (based on Markov Chains) may be introduced for each radio communication cell in order to quantify the usage characteristics of each cell (in other words: each mobile radio base station). By way of example, a state diagram may be defined for each mobile radio cell (in other words: each mobile radio base station) where each state corresponds to a distinct number of users connected to the relevant mobile radio cell, in other words the relevant mobile radio base station (however, other approaches are also feasible: each state could also be chosen to correspond to a sub-set of communication resources and the mobile radio cell may be required to derive statistics on the allocation of resources instead of users). Such a state diagrams will be illustrated with reference to FIG. 7A, FIG. 7B, and FIG. 7C.

FIG. 7A shows a mobile radio cell state diagram representation 700 in accordance with an embodiment.

In various embodiments, 702₀, 702₁, 702₂, . . . , 702ᵢ₋₁, 702ᵢ represent the state where 0, 1, 2, i−1 resp. i users are connected to the mobile radio cell (in other words: to the mobile radio base station). In other words, a state 702ⱼ with any natural number j represents the state where j users are connected to the mobile radio cell (in other words: to the mobile radio base station).

In various embodiments, 706₀, 706₁, . . . , 706ᵢ₋₁ indicate the “birth” probabilities, i.e. the probability that a new user enters the considered mobile radio cell. In other words: 706ⱼ with any natural number j may indicate the probability, that a user enters the cell, i.e. that the state of the cell changes from 702ⱼ to 702ⱼ₊₁, i.e. that the number of users served by the mobile radio base station increases from j to j+1.

In various embodiments, 708₁, 708₂, . . . , 708ᵢ indicate the “death” probabilities, i.e. the probability that a user leaves the considered mobile radio cell. In other words: 708ⱼ with any natural number j indicates the probability, that a user leaves the mobile radio cell, i.e. that the state of the mobile radio cell changes from 702ⱼ to 702ⱼ₋₁, i.e. that the number of users served by the mobile radio base station decreases from j to j−1.

In various embodiments, 704₀, 704₁, 704₂, . . . , 704ᵢ₋₁, 704ᵢ indicate the “no-event” probability, i.e. the probability that the number of users served by a mobile radio cell remains constant. It is to be noted that this may mean that neither a user is leaving nor is a new one arriving, but it can also indicate that as many users are arriving as there are users leaving. In other words: 704ⱼ with any natural number j indicates the probability, that the number of users in a mobile radio cell remains constant, i.e. that the state of the cell remains at 702ⱼ, i.e. the number of users served by the mobile radio base station remains at j.

In various embodiments, states may be chosen to represent usage levels, e.g. such as “small number of users”, “medium number of users”, “large number of users”, and so on. This may lead to smaller state diagrams.

FIG. 7B shows a mobile radio cell state diagram representation 710 in accordance with an embodiment, where, instead of a number of users (like shown with reference to FIG. 7A), the more abstract states “small number of users”, “medium number of users”, “large number of users” and “too many users (saturation)” may be used.

In various embodiments, 712₀ represents a state with a small number of users connected to the cell. 712₁ represents a state with a medium number of users connected to the mobile radio cell, 712₂ represents a state with a large number of users connected to the mobile radio cell, and 712₃ represents a state with too many users connected to the mobile radio cell.

In various embodiments, “small number”, “medium number”, “large number” and “too many users” may be defined to best suit the current purpose.

In various embodiments, 716₀, 716₁, and 716₂ indicate the “birth” probability of the respective states. By way of example, 716₀ may indicate the probability that the number of users connected with the mobile radio cell increases from a small number to a medium number, 716₁ indicates the probability that the number of users connected with the mobile radio cell increases from a medium number to a large (but not as large as to be to high) number, and 716₂ indicates the probability that the number of users connected with the mobile radio cell increases from a large (but not as large as to be to high) number to a number of too many users.

In various embodiments, 718₁, 718₂, and 718₃ indicate the “death” probability of the respective states. By way of example, 718₁ may indicate the probability that the number of users connected with the mobile radio cell decreases from a medium number to a small number, 718₂ indicates the probability that the number of users connected with the mobile radio cell decreases from a large (but not as large as to be too high) number to a medium number, and 718₃ indicates the probability that the number of users connected with the mobile radio cell increases from a number of too many users to a large (but not as large as to be to high) number.

In various embodiments, 714₀, 714₁, 714₂ and 714₃ indicate the “no-event” probability, i.e. the probability that the number of users served by a mobile radio cell remains either in the range of a small number of users connected to the mobile radio cell (probability 714₀), or in the range of a medium number of users connected to the mobile radio cell (probability 714₁), or in the range of a large (but not as large as to be too high) number of users connected to the mobile radio cell (probability 714₂), or in the range of a number of too many users connected to the cell (probability 714₃).

It is to be noted that the state diagrams of FIG. 7A and FIG. 7B only address the case where the mobile radio cell is turned on and open for communication. The state diagrams of FIG. 7A and FIG. 7B are of no relevance during set-up time, etc.

In various embodiments, a time interval ΔT₀ may be introduced, after which one of the three above-defined actions may occur (i.e., “birth”, “death” or “no-event”). This time-interval may be chosen in function of the average interval during which an event occurs in a specific deployment. It may be obtained empirically.

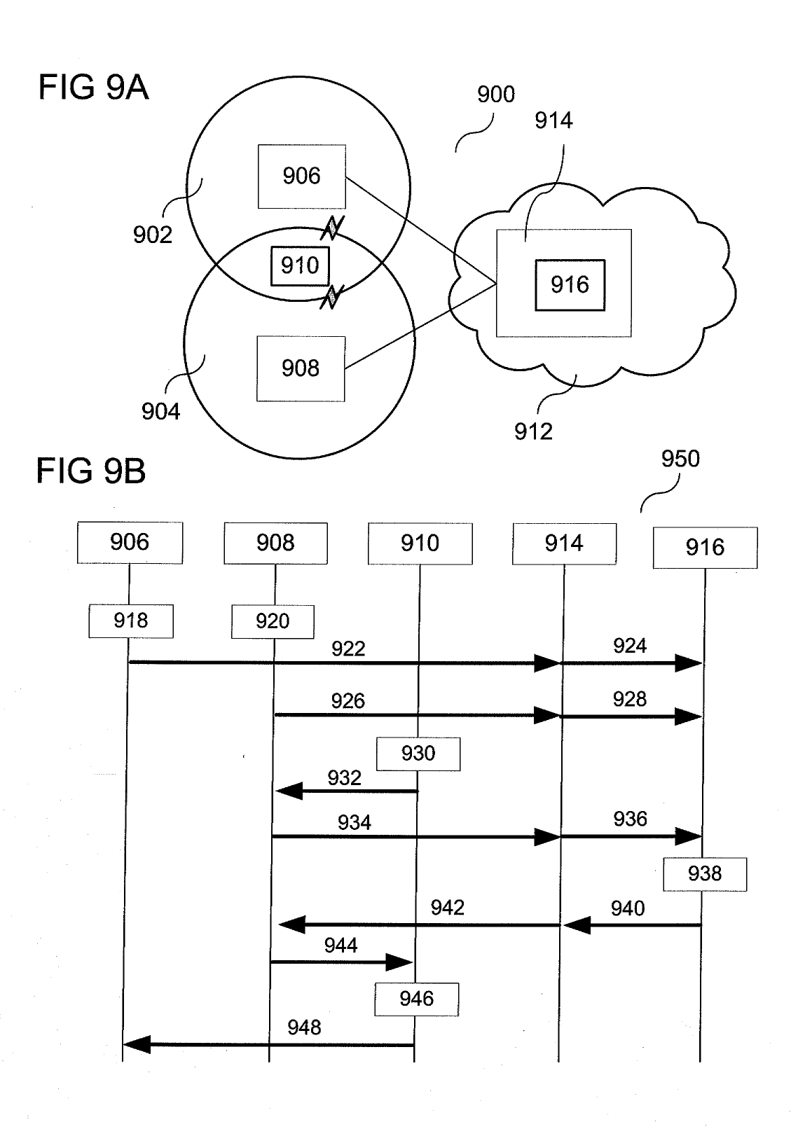

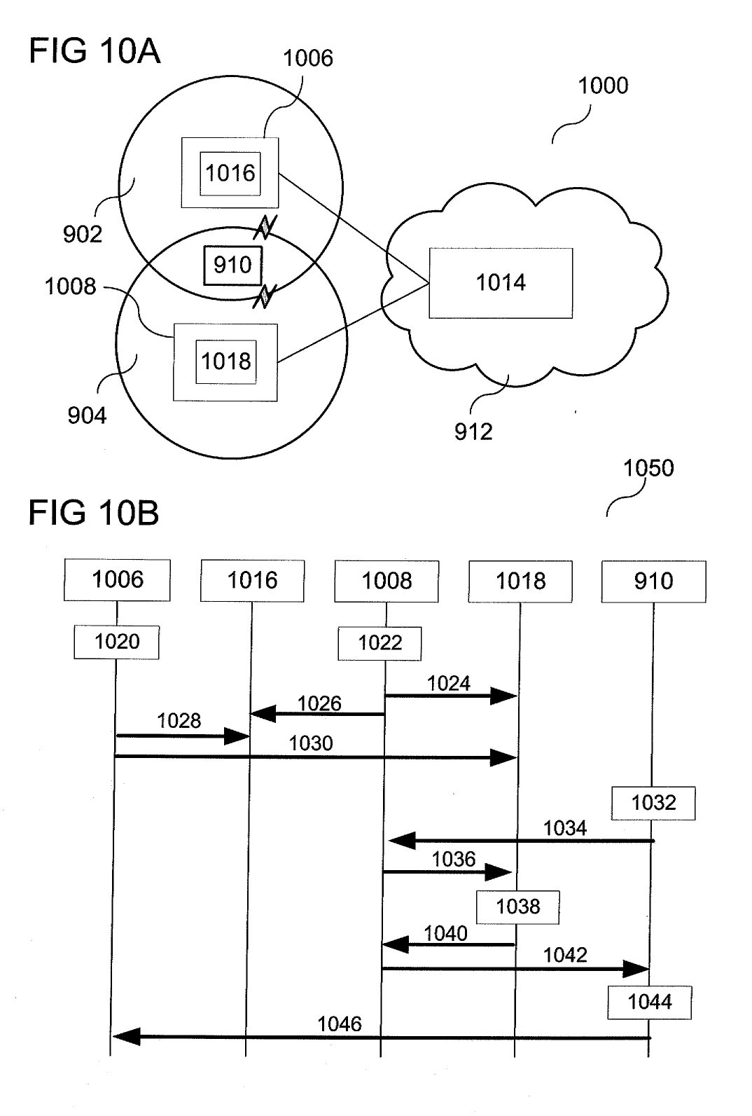

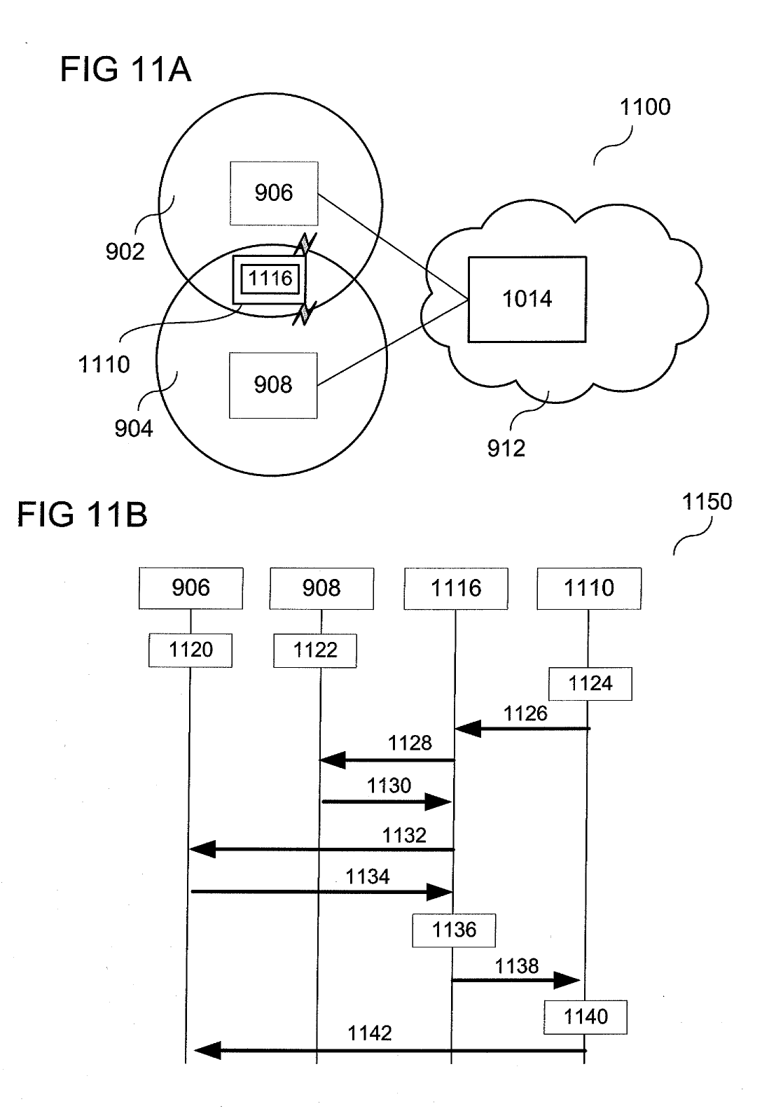

Each mobile radio cell (in other words: each mobile radio base station) may derive the upper parameters (704ⱼ, 706ⱼ, 708ⱼ resp. 714ⱼ, 716ⱼ, 718ⱼ) by long term observation of the user behaviour (in other words: the load situation history; in other words: the usage characteristics). In other words: the parameters may be obtained empirically by observing the state and the state transition probabilities within each mobile radio cell. The derivation of parameters may need to be restarted as soon as the context changes, e.g. when the mobile radio cell is moved to another location, etc. The parameters may be derived independently for various periods over a day or a week. During night time or over the week-end, for example, the level of activity may be lower compared to a busy period in the morning or afternoon. The decision making device (mobile radio base station selecting device) deciding on the selection of a mobile radio cell may know the above parameters (704ⱼ, 706ⱼ, 708ⱼ resp. 714ⱼ, 716ⱼ, 718ⱼ) for each mobile radio base station, e.g. for each femtocell base station. The decisions making device (the selecting device) may be implemented into the mobile radio communication terminal device, the mobile radio cell (e.g. a mobile radio base station, e.g. a femtocell base station) or in the mobile radio communication network (e.g. in a gateway, e.g. a femtocell gateway). This will be illustrated in more detail below with reference to FIG. 9, FIG. 10, and FIG. 11.

Based on this knowledge, the future saturation probability may be evaluated for each mobile radio cell assuming that a mobile radio cell is saturated as soon as a maximum number of “i=Uₘₐₓ” users are served. In various embodiments, saturation may be related to the maximum number of users. In various embodiments, saturation may be understood as the case where at least a pre-defined number of instances of a resource that is available in a certain number is used. In various embodiments, the resources may be one or more of the following resources: a computational resource, a processor, a dedicated hardware circuit, an application-specific integrated circuit, a field-programmable gate array, a software-defined radio circuit, a digital signal processor, a memory circuit, a radio interface circuit, a cable connection circuit, an asymmetric digital subscriber line circuit, a battery, an output power limitation circuit, a power budget circuit, and an antenna.

FIG. 7C shows a mobile radio cell state diagram representation 730 in accordance with an embodiment. The mobile radio cell state diagram representation 730 of FIG. 7C differs from the mobile radio cell state diagram representation 700 of FIG. 7A in that the saturation region 720 is indicated. The saturation region 720 marks those states, where more users than the maximum number of “i=Uₘₐₓ” users are served by the mobile radio cell. In other words: the mobile radio cell is saturated in all states 702ⱼ, where j is equal to or larger than i, and i equals Uₘₐₓ.

In the following, the birth probability (i.e. 706ⱼ resp. 716ⱼ) is denoted by bj, the death probability (i.e. 708j resp. 718j) is denoted by dⱼ, and the no-event probability (i.e. 704ⱼ resp. 714ⱼ) is denoted by aⱼ. This approach may be considered to be based on a quasi-static behavior. In various embodiments, various measures may depend on the current context and may slowly change over time. This time-dependence may be considered to be negligible for a specific decision in the very short term, but it may influence the longer-term behavior of the system.

In various embodiments, for the selection of a suitable mobile radio cell among multiple available mobile radio cells, different saturation probabilities can be derived, depending on the preferred selection criteria.

In various embodiments, in a long term approach, the saturation probability may be calculated by using Markov-Chains models in order to derive the probability for a mobile radio cell being in one of the possible states. The probability “pᵢ” that the femtocell base station is in state “i” may be given by

$${p}_{i} = \frac{{b}_{t - 1}}{{d}_{i}} {p}_{i - 1} = {\prod }_{j = 1}^{i} \frac{{b}_{j - 1}}{{d}_{j}} {p}_{0} \qquad ( 1 )$$

and with

$${p}_{0} = \frac{1}{{\sum }_{i \geq 0} {{\prod }_{j = 1}}^{i} \frac{{b}_{j - 1}}{{d}_{j}}} . \qquad ( 2 )$$

Based on these results, the saturation probability “pₛₐₜ” may be calculated as

$${p}_{sat} = {\sum }_{k \geq {U}_{max}} {p}_{k} = {\sum }_{k \geq {U}_{max}} {\prod }_{j = 1}^{k} \frac{{b}_{j - 1}}{{d}_{j}} {p}_{0} . \qquad ( 3 )$$

According to various embodiments, the corresponding saturation probabilities “pₛₐₜ” for each of the cells a specific user may connect to may be calculated and the cell with the lowest saturation probability “pₛₐₜ” may be chosen.

According to this embodiment, the derivation of the saturation probability “pₛₐₜ” does not take the current mobile radio cell state into account and thus may be considered as a long term measure.

In various embodiments, for a shorter-term measure, another approach may be used, which also may take the current mobile radio cell state into account.

In various embodiments, in a short term approach, the saturation probability may be calculated by taking into account

i) the current state of the considered mobile radio cell,

ii) the state transition time interval (ΔT₀) and the state transition probabilities as introduced above (“bᵢ”, “dᵢ” and “aᵢ”).

A time period until the next H/O could occur may be introduced: T_{H/O}, i.e. for each considered mobile radio cell, the next

$$“ \frac{{T}_{H \text{/} O}}{Δ {T}_{0}} ”$$

transitions may be considered starting from the current state of each considered mobile radio cell. The approach according to various embodiments may include calculating the probability, starting from the current state of each considered mobile radio cell, that this mobile radio cell is in a saturation state (i.e., a state “i>=Uₘₐₓ”). By way of example, the amount of time (e.g. expressed in cycles of duration ΔT₀) that a mobile radio cell is in a saturation state during the overall observation duration T_{H/O} may be calculated. The mobile radio communication terminal device (or a mobile radio base station or a gateway server) may select for the link the mobile radio cell that has the lowest saturation time or saturation probability. The corresponding saturation time or saturation probability values may be difficult to calculate analytically. According to an embodiment, the corresponding values may be derived by a short Monte-Carlo simulation. According to another embodiment, these values may be determined by off-line Monte-Carlo simulations (which determine all solutions for selected possible parameters sets (bᵢ, dᵢ, aᵢ), e.g. by introducing a chosen granularity (such as a maximum number of bits) and by performing simulations for all possible permutations) and may be stored in the corresponding cells and/or the decision making devices (mobile radio base station selecting devices). The latter approach may require a large memory depending on the number of permutations that are considered.

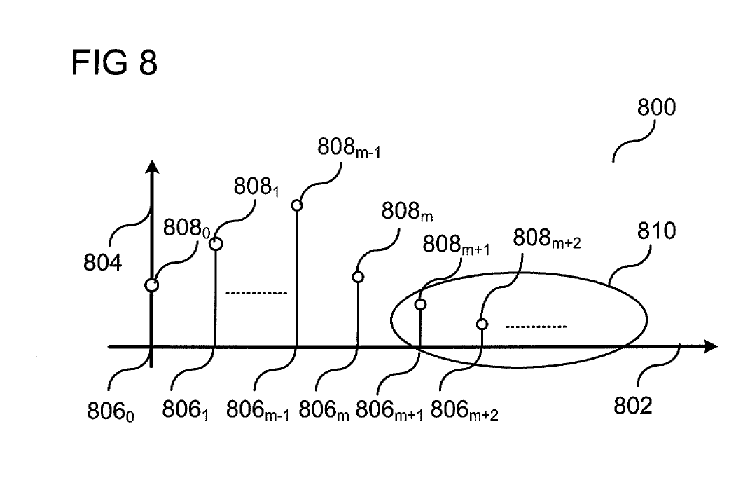

According to various embodiments, the saturation probability may also be derived by a long term observation of the various states of the state machine and a direct derivation of a Probability-Density-Function (PDF) describing the probability that a mobile radio cell is in a given state. The saturation probability would then correspond to the sum of the elements of the PDF that are measured in saturation states as will be explained in more detail with reference to FIG. 8.

FIG. 8 shows a probability density function representation 800 in accordance with an embodiment of a probability density function based approach for deriving the saturation probability.

In FIG. 8, the axis 802 represents the number of users served by a mobile radio cell. The axis 804 represents the probability of the respective states.

In various embodiments, 806₀, 806₁, 806ₘ₋₁, 806ₘ, 806ₘ₊₁, and 806ₘ₊₂ may represent the states where 0, 1, m−1, m, m+1 and m+2 users, respectively, are served by the respective mobile radio cell. In other words: 806ⱼ with any natural number represents the state where j users are served by the respective mobile radio cell.

In various embodiments, 808₀, 808₁, 808ₘ₋₁, 808ₘ, 808ₘ₊₁, and 808ₘ₊₂ may represent the probability that the state machine is in the state 806₀, 806₁, 806ₘ₋₁, 806ₘ, 806ₘ₊₁, and 806ₘ₊₂, respectively, and 0, 1, m−1, m, m+1 and m+2 users are served by the respective mobile radio cell, respectively. In other words: 808ⱼ with any natural number j may represent the probability that the mobile radio cell is in a state 806ⱼ where j users are served by the respective mobile radio cell.

In case m is the maximum number of users that may be served by the respective mobile radio cell, then the sum of the probabilities of all states 810 where more than m users are served (in other words: try to be served or want to be served) by the respective mobile radio cell may be the saturation probability.

According to various embodiments, the probability density function may be established based on a state machine with a limited number of states like explained with reference to FIG. 7B.

The respective decision making device (mobile radio base station selecting device) may be located in different entities, i.e. in the mobile radio communication terminal device, the mobile radio cells (e.g. mobile radio base stations, e.g. femtocell base stations) or in the network (e.g. in a gateway, e.g. a femtocell gateway), as will in the following be illustrated with reference to FIG. 9, FIG. 10, and FIG. 11.

FIG. 9A shows a mobile radio communication system 900 where the mobile radio base station selecting device is included in a gateway server in accordance with an embodiment. In various embodiments, a first mobile radio base station 906 may provide a first coverage area 902, and a second mobile radio base station 908 may provide a second coverage area 904. A mobile radio communication terminal device 910 may be in both the first coverage area 902 and the second coverage area 904. A gateway server 914 may be provided in the mobile radio core network 912. The gateway server 914 may be connected to the mobile radio base station 906 and the second mobile radio base station 908. Although only two mobile radio base stations are shown in FIG. 9A, any number of mobile radio base stations may be present, and each mobile radio base station may provide a coverage area. A mobile radio base station selecting device 916 may be provided in the gateway server 914.

FIG. 9B shows a message flow diagram 950 illustrating a method for selecting a mobile radio base station out of a plurality of mobile radio base stations serving a communication terminal for communication with the communication mobile radio communication terminal device in accordance with an embodiment.

In 918, the mobile radio base station 906 may acquire information about its load history (as an implementation of the usage characteristics) and the current load situation. It may record the load history data directly, or it may compute parameters for a computational model of the load history or it may compute the saturation probability as described above. Depending on whether and how the load history data is processed, in 922, the mobile radio base station may transmit the load data directly or the computed results (e.g. the parameters for the computational model or the computed saturation probability) to the gateway server 914. The gateway server 914 may, in 924, forward the data to the mobile radio base station selection device 916.

In 920, the second mobile radio base station 908 may acquire information about its load history (as an implementation of the usage characteristics) and the current load situation. It may record the load history data directly, or it may compute parameters for a computational model of the load history or it may compute the saturation probability as described above. Depending on whether and how the load data is processed, in 926 the mobile radio base station may transmit the load data directly or the computed results (e.g. the parameters for the computational model or the computed saturation probability) to the gateway server 914. The gateway server 914 may, in 928, forward the data to the mobile radio base station selection device 916.

In 930, the mobile radio communication terminal device 910 may be switched on. Alternatively, the mobile radio communication terminal device 910, in 930, may try to get connection in the coverage area of the mobile radio communication mobile radio base stations 906, 908 for the first time, e.g. because it enters the respective location area for the first time, while already having been switched on at an earlier time.

In 932, the mobile radio communication terminal device 910 may send a connection request to the second mobile radio base station 908. Alternatively, the mobile radio communication terminal device 910, in 932, may send a request for information about with which mobile radio base station to connect to the mobile radio base station 908.

In 934, the second mobile radio base station 908 may transmit the request (i.e. the connection request or the request for information about with which mobile radio base station the mobile radio communication terminal device should connect) to the gateway server 914. In 936, the gateway server may forward the request to the mobile radio base station selecting device 916. Because the mobile radio base station selecting device 916 is included in the gateway server 914, transmitting the data may be carried out via an electrical connection such as e.g. a cable or a computer bus or via any other suitable electrical connection to exchange electrical signals.

In 938, the mobile radio base station selecting device 916 may refer to the information received in 924 and 928, to acquire the information about with which mobile radio base station the mobile radio communication terminal device 910 should connect. The mobile radio base station selecting device 916 may perform further processing on the information received in steps 924 and 928, e.g. the mobile radio base station selecting device 916 may evaluate a computational model with parameters included in the information received in 924 and 928 and/or may compute the saturation probability as described above.

Although not shown in FIG. 9B, upon receiving the request in 936, the mobile radio base station selecting device 916 may acquire information from the mobile radio base stations 906, 908. In other words: the data may not only be transmitted in advance as shown in FIG. 9B in 922, 924, 926, and 928 from the mobile radio base stations 906, 908 to the mobile radio base station selecting device 916, but may additionally or alternatively be transmitted upon being requested by the mobile radio base station selecting device 916.

After having acquired the information in 938, the mobile radio base station selecting device 916 may transmit the information to the gateway server 914 in 940. The gateway server 914 may transmit the information to the mobile radio communication terminal device 910 via the mobile radio base station 908 (e.g. in 942 and 944).

In 946, the mobile radio communication terminal device 910 may receive and evaluate the information. For illustrating purposes, it may be assumed that the information received by the mobile radio communication terminal device 910 indicates that connection should be made to the first mobile radio base station 906, and, in 948, the mobile radio communication terminal device 910 may transmit a connection request to the second mobile radio base station 908. Then, a communication connection may be established between the mobile radio communication terminal device 910 and the second mobile radio base station 908 with a conventionally used method.

In various embodiments, although not shown in FIG. 9B, the mobile radio communication terminal device 910 may receive information about with which mobile radio base station to connect not upon request, but e.g. automatically, e.g. by use of a pilot channel.

In the scenario shown in FIG. 9A, the decision making device (mobile radio base station selecting device) is located in the network (e.g. a gateway, e.g. a femtocell gateway). In this case, the mobile radio cell gateway may be gathering all information of relevant mobile radio cells including their usage characteristics. This facilitates the derivation of a globally optimum assignment of each mobile radio communication terminal device to specific mobile radio cells. In this scenario, it may be provided to deliver mobile radio cell usage characteristics from each mobile radio cell to the mobile radio cell gateway. It may be provided to perform calculations related to the global optimization on which mobile radio communication terminal device should connect to which mobile radio cell, and this calculation may have to be performed in the mobile radio cell gateway and the required calculation devices (i.e. CPU-power, etc.) may be provided by the mobile radio cell gateway. The decisions of the mobile radio cell gateway may be communicated to each mobile radio communication terminal device.

In other words, an example on the usage of the mechanisms introduced above with reference to FIG. 9A and FIG. 9B is as follows (based on the embodiment that the decision making device (mobile radio base station selecting device) is provided in the mobile radio communication network (e.g. in a gateway), e.g. in a femtocell gateway:

A) A mobile radio communication terminal device may be switched on in an area where multiple mobile radio cells, e.g. femtocells, are present, i.e. the mobile radio communication terminal device may have coverage from multiple mobile radio cells, e.g. femtocells;

B) The femtocells or femtocell base stations may have (already beforehand) calculated their usage characteristics, e.g. based on a computational model, e.g. the Markov-model presented above. They may have communicated these usage characteristics to the mobile radio communication network (e.g. a gateway, e.g. a femtocell gateway). The mobile radio communication network (e.g. a gateway, e.g. a femtocell gateway) may have already received these usage characteristics and may derive a suitable link for the new mobile radio communication device to a mobile radio cell, e.g. a femtocell, exploiting this information;

C) The mobile radio communication network (e.g. a gateway, e.g. a femtocell gateway) may be communicating to the mobile radio communication terminal device and may indicate which mobile radio cell, e.g. which femtocell, the mobile radio communication terminal device should use;

D) The mobile radio communication terminal device may establish the link to the preferred mobile radio cell, e.g. the preferred femtocell, as indicated by the mobile radio communication network (e.g. a gateway, e.g. a femtocell gateway).

FIG. 10A shows a mobile radio communication system 1000 where the mobile radio base station selecting device is included in the mobile radio base stations in accordance with an embodiment. In various embodiments, a first mobile radio base station 1006 may provide a first coverage area 902, and a second mobile radio base station 1008 may provide a second coverage area 904. A mobile radio communication terminal device 910 may be located in both the first coverage area 902 and the second coverage area 904. A gateway server 1014 may be provided in the mobile radio communication core network 912. The gateway server 1014 may be connected to the first mobile radio base station 1006 and the second mobile radio base station 1008. Although only two mobile radio base stations are shown in FIG. 10A, any number of mobile radio base stations may be present, and each mobile radio base station may provide a coverage area. A mobile radio base station selecting device 1016 may be provided in the mobile radio base station 1006, and a mobile radio base station selecting device 1018 may be provided in the mobile radio base station 1008.

FIG. 10B shows a message flow diagram 1050 illustrating a method for selecting a mobile radio base station out of a plurality of mobile radio base stations serving a communication terminal for communication with the communication mobile radio communication terminal device in accordance with an embodiment.

In 1020, the mobile radio base station 1006 may acquire information about its load history (an implementation of the usage characteristics) and the current load situation. It may record the load history data directly, or it may compute parameters for a computational model of the load history or it may compute the saturation probability as described above. Depending on whether and how the load data is processed, in 1028 the mobile radio base station may transmit the load data directly or the computed results (e.g. the parameters for the computational model or the computed saturation probability) to the mobile radio base station selecting device 1016. Because the mobile radio base station selecting device 1016 is included in the mobile radio base station 1006, transmitting the data may be carried out via an electrical connection such as e.g. a cable or a computer bus or via any other suitable electrical connection to exchange electrical signals.

In 1030, the mobile radio base station may transmit the load data directly or the computed results (e.g. the parameters for the computational model or the computed saturation probability) to the mobile radio base station selecting device 1018. Because the mobile radio base station selecting device 1018 is included in the mobile radio base station 1008, and the mobile radio base stations 1006 and 1008 are connected to the gateway server 1014, transmitting the data may be carried out via the gateway server 1014, although this is not shown in FIG. 10B.

In 1022, the mobile radio base station 1008 may acquire information about its load history (in other words: the usage characteristics) and the current load situation. It may record the load history data directly, or it may compute parameters for a computational model of the load history or it may compute the saturation probability as described above. Depending on whether and how the load data is processed, in 1024, the mobile radio base station may transmit the load data directly or the computed results (e.g. the parameters for the computational model or the computed saturation probability) to the mobile radio base station selecting device 1018. Because the mobile radio base station selecting device 1018 is included in the second mobile radio base station 1008, transmitting the data may be carried out via an electrical connection such as e.g. a cable or a computer bus or via any other suitable electrical connection to exchange electrical signals.

In 1026, the mobile radio base station may transmit the load data directly or the computed results (e.g. the parameters for the computational model or the computed saturation probability) to the mobile radio base station selecting device 1016. Because the mobile radio base station selecting device 1016 is included in the mobile radio base station 1006, and the mobile radio base stations 1006 and 1008 are connected to the gateway server 1014, transmitting the data may be carried out via the gateway server 1014, although this is not shown in FIG. 10B.

In 1032, the mobile radio communication terminal device 910 may be switched on. Alternatively, the mobile radio communication terminal device 910, in step 1032, may try to get connection in the coverage area of the mobile radio communication mobile radio base stations 1006, 1008 for the first time, e.g. because it enters the respective location area for the first time, while already having been switched on at an earlier time.

In 1034, the mobile radio communication terminal device 910 may send a connection request to the second mobile radio base station 1008. Alternatively, the mobile radio communication terminal device 910, in 1034, may send a request for information about with which mobile radio base station to connect to the mobile radio base station 1008.

Upon reception of the request, the mobile radio base station may start processing to acquire the information about the load situation at the respective mobile radio base stations. In 1036, the second mobile radio base station 1008 may transmit a request for information about with which mobile radio base station the mobile radio communication terminal device 910 should connect) to the mobile radio base station selecting device 1018 provided in the mobile radio base station 1008 itself. Because the mobile radio base station selecting device 1018 is included in the second mobile radio base station 1008, transmitting the data may be carried out via an electrical connection such as e.g. a cable or a computer bus or via any other suitable electrical connection to exchange electrical signals.

In 1038, the mobile radio base station selecting device 1018 may refer to the information received in 1024, 1030 to acquire the information about with which mobile radio base station the mobile radio communication terminal device 910 should connect. The mobile radio base station selecting device 1018 may perform further processing on the information received in 924, 928, e.g. the mobile radio base station selecting device 1018 may evaluate a computational model with parameters included in the information received in steps 1024, 1030 or may compute the saturation probability.

Although not shown in FIG. 10B, upon receiving the request in 1036, the mobile radio base station selecting device 1018 may acquire information from the mobile radio base stations 1006, 1008. In other words: the data may not only be transmitted in advance from all mobile radio base stations 1006, 1008 to all mobile radio base station selecting devices 1016, 1018 as shown in FIG. 10B in 1024, 1026, 1028, 1030, but may additionally or alternatively be transmitted upon being requested by the mobile radio base station selecting devices 1016, 1018.

After having acquired the information in step 1038, the mobile radio base station selecting device 1018 may transmit the mobile radio base station 1008 in 1040. The second mobile radio base station 1008 may transmit the information to the mobile radio communication terminal device 910 in 1042.

In 1044, the mobile radio communication terminal device 910 may receive and evaluate the information. For illustrating purposes, it may be assumed that the information received by the mobile radio communication terminal device 910 indicates that connection should be made to the first mobile radio base station 1006, and, in 1046, the mobile radio communication terminal device 910 may transmit a connection request to the mobile radio base station 1008. Then, a communication connection may be established between the mobile radio communication terminal device 910 and the mobile radio base station 1008 with a conventionally used method.

In various embodiments, although not shown in FIG. 10B, the mobile radio communication terminal device 910 may receive information about with which mobile radio base station to connect not upon request, but e.g. automatically, e.g. by use of a pilot channel.

In the scenario shown in FIG. 10A, the decision making device (mobile radio base station selecting device) may be located in each mobile radio base station, e.g. in a femtocell base station. In this case, each mobile radio cell (in other words: each mobile radio base station, e.g. each femtocell base station) may derive information of its own usage characteristics. In order to evaluate the best link strategy of each mobile radio communication terminal device to specific mobile radio cells, the mobile radio cells may need to exchange information about the usage characteristics. A link between mobile radio cells may need to be established each time this information is exchanged. The mobile radio cells may need to decide in which mobile radio cell the information is collected and which mobile radio cell is finally doing the link selection optimization.

Although in FIG. 10B it is shown that all mobile radio base stations 1006, 1008 transmit data about the user characteristics to all mobile radio base station selecting devices 1016, 1018, a mobile radio base station selecting device out of the mobile radio base station selecting devices 1016, 1018 may be selected to perform the data collection and decision. Furthermore, the mobile radio base station selecting device that is provided in the mobile radio base station to which the mobile radio communication terminal device 910 first transmits a request for connection or selection information, may perform the data collection and decision.

The decisions of the mobile radio cell inherent decision making device (mobile radio base station selecting device) may need to communicate the result (i.e. the selected mobile radio cell for each mobile radio communication terminal device) back to the mobile radio communication terminal device.

In other words, an example on the usage of the mechanisms introduced above with reference to FIG. 10A and FIG. 10B is as follows (based on the example that the decision making device (mobile radio base station selecting device) is provided in a mobile radio base station (in other words: in a mobile radio cell), e.g. in a femtocell base station):

A) A mobile radio communication terminal device may be switched on in an area where multiple mobile radio base stations (in other words: multiple cells), e.g. femtocell base stations are present, i.e. the mobile radio communication terminal device may have coverage from multiple femtocells;

B) The mobile radio base stations (in other words: the mobile radio cells), e.g. femtocell base stations, may have (already beforehand) calculated their usage characteristics based on a computational model, e.g. the Markov-model described above. They may have communicated these usage characteristics to a selected mobile radio base station (in other words: to the selected mobile radio cell), e.g. femtocell base station, which gathers all of the information. This selected mobile radio base station (in other words: this selected mobile radio cell), e.g. femtocell base station, may derive a suitable link for the new mobile radio communication terminal device to a mobile radio base station (in other words: mobile radio cell), e.g. femtocell base station, exploiting this information.

C) The selected mobile radio base station (in other words: the selected mobile radio cell), e.g. the selected femtocell base station, may be communicating to the mobile radio communication terminal device and may indicate which mobile radio base station (in other words: which mobile radio cell), e.g. femtocell or femtocell base station, the mobile radio communication terminal device should use;

D) The mobile radio communication terminal device may establish the link to the preferred mobile radio base station (in other words: the preferred mobile radio cell), e.g. femtocell base station, as indicated by the mobile radio communication network (e.g. by a gateway, e.g. by a femtocell gateway).

FIG. 11A shows a mobile radio communication system 1100 where the mobile radio base station selecting device is included in the mobile radio communication terminal device in accordance with an embodiment. In various embodiments, a first mobile radio base station 906 may provide a first coverage area 902, and a second mobile radio base station 908 may provide a second coverage area 904. A radio communication mobile radio communication terminal device 1110 may be in both the first coverage area 902 and the second coverage area 904. A gateway server 1014 may be provided in the mobile radio core network 912. The gateway server 1014 may be connected to the first mobile radio base station 906 and the second mobile radio base station 908. Although only two mobile radio base stations are shown in FIG. 11A, any number of mobile radio base stations may be present, and each mobile radio base station may provide a coverage area. A mobile radio base station selecting device 1116 may be provided in the mobile radio communication terminal device 1110.

FIG. 11B shows a message flow diagram 1150 illustrating a method for selecting a mobile radio base station out of a plurality of mobile radio base stations serving a communication terminal for communication with the mobile radio communication terminal device in accordance with an embodiment.

In 1120, the mobile radio base station 906 may acquire information about its load history (one implementation of the usage characteristics) and the current load situation. It may record the load history data directly, or it may compute parameters for a computational model of the load history or it may compute the saturation probability as described above.

In 1122, the second mobile radio base station 908 may acquire information about its load history and the current load situation. It may record the load history data directly, or it may compute parameters for a computational model of the load history or it may compute the saturation probability as described above.

In 1124, the mobile radio communication terminal device 1110 may be switched on. Alternatively, the mobile radio communication terminal device 1110, in 1124, may try to get connection in the coverage area of the mobile radio communication mobile radio base stations 906, 908 for the first time, e.g. because it enters the respective location area, while already having been switched on at an earlier time for the first time.

In 1126, the mobile radio communication terminal device 1110 may refer to the mobile radio base station selecting device 1116 provided in the mobile radio communication terminal device 1110 itself to request information about with which mobile radio base station it should connect. Because the mobile radio base station selecting device 1116 is included in the mobile radio communication terminal device 1110, transmitting the data may be done via an electrical connection such as e.g. a cable or a computer bus or via any other suitable electrical connection to exchange electrical signals.

The mobile radio base station selecting device 1116, in 1128, may request information about the load situation from the second mobile radio base station 908. Although in FIG. 11B the information flow is shown from the mobile radio base station selecting device 1116 directly to the second mobile radio base station 908, the data flow may be from the mobile radio base station selecting device 1116 via the mobile radio communication terminal device 1110 to the second mobile radio base station 908.

In 1130, the second mobile radio base station 908 provides the requested data to the mobile radio base station selecting device 1116. Depending on whether and how the load data is processed in the second mobile radio base station 908, in 1130, the second mobile radio base station 908 may transmit the load data directly or the computed results (e.g. the parameters for the computational model or the computed saturation probability) to the mobile radio base station selecting device 1116. Although in FIG. 11B the information flow is shown from the second mobile radio base station 908 directly to the mobile radio base station selecting device 1116, the data flow may be from the second mobile radio base station 908 via the mobile radio communication terminal device 1110 to the mobile radio base station selecting device 1116.

The mobile radio base station selecting device 1116, in 1132, may request information about the load situation from the first mobile radio base station 906. Although in FIG. 11B the information flow is shown from the mobile radio base station selecting device 1116 directly to the first mobile radio base station 906, the data flow may be from the mobile radio base station selecting device 1116 via the mobile radio communication terminal device 1110 to the first mobile radio base station 906.

In 1134, the first mobile radio base station 906 may provide the requested data to the mobile radio base station selecting device 1116. Depending on whether and how the load data is processed in the first mobile radio base station 906, in 1134, the first mobile radio base station 906 may transmit the load data directly or the computed results (e.g. the parameters for the computational model or the computed saturation probability) to the mobile radio base station selecting device 1116. Although in FIG. 11B the information flow is shown from the first mobile radio base station 906 directly to the mobile radio base station selecting device 1116, the data flow may be from the first mobile radio base station 906 via the mobile radio communication terminal device 1110 to the mobile radio base station selecting device 1116.

Although in the above description with reference to FIG. 11B, the information about the load situation at the respective mobile radio base stations may be requested from the mobile radio base station selecting device (in other words: the information retrieval may be implemented as a pull mode), the information may be delivered to the mobile radio communication terminal device without being requested (in other words: the information retrieval may be implemented as a push mode), e.g. by use of pilot channels of the respective mobile radio base station, which may transmit the information continuously.

In 1136, the mobile radio base station selecting device 1118 may refer to the information received in 1130, 1134 to acquire the information about with which mobile radio base station the mobile radio communication terminal device 910 should connect. The mobile radio base station selecting device 1118 may perform further processing on the information received in 1130, 1134, e.g. the mobile radio base station selecting device 1018 may evaluate a computational model with parameters included in the information received in 1130, 1134 and/or may compute the saturation probability as described above.

After having acquired the information in 1136, the mobile radio base station selecting device 1116 may transmit the information to the mobile radio communication terminal device 1100 in 1138. Because the mobile radio base station selecting device 1116 is included in the mobile radio communication terminal device 1110, transmitting the data may be carried out via an electrical connection such as e.g. a cable or a computer bus or via any other suitable electrical connection to exchange electrical signals.

In 1140, the mobile radio communication terminal device 1110 may receive and evaluate the information. For illustrating purposes, it may be assumed that the information received by the mobile radio communication terminal device 1110 indicates that connection should be made to the first mobile radio base station 906, and, in 1142, the mobile radio communication terminal device 1110 may transmit a connection request to the first mobile radio base station 906. Then, a communication connection may be established between the mobile radio communication terminal device 1110 and the first mobile radio base station 906 with a conventionally used method.

In various embodiments, although not shown in FIG. 11B, the mobile radio communication terminal device 1110 may receive information about with which mobile radio base station to connect not upon request, but e.g. automatically, e.g. by use of a pilot channel.

In the scenario shown in FIG. 11A, the decision making device (mobile radio base station selecting device) is located in the mobile radio communication terminal device. If the decisions on which mobile radio base station (in other words: which mobile radio cell, e.g. which femtocell base station) to connect to is done within each mobile radio communication terminal device, the following procedure may be provided:
each mobile radio cell (in other words: each mobile radio base station) may derive its own usage characteristics and may be communicating this to each mobile radio communication terminal device by (secure) broadcasting the relevant information (“push-mode”) or by providing it to a specific mobile radio communication terminal device upon request (“pull-mode”); and
each mobile radio communication terminal device may be collecting the usage characteristics of all relevant neighboring mobile radio cells (e.g. femtocells) and may be performing the selection on its own, i.e. the optimization process for the derivation of the best suited mobile radio cell (e.g. femtocell) may require calculation devices (e.g. CPU-power, etc.) which may be present in the mobile radio communication terminal device.

In case of the various embodiments where the decision making device (e.g. mobile radio base station selecting device) is located in the mobile radio cell gateway (e.g. in the femtocell gateway), the calculation power requirements are concentrated in one single node and the various mobile radio cells (e.g. femtocells) may have to communicate the information about the load situation (e.g. parameters for a computational model, e.g. Markov-Parameters) as indicated above to this mobile radio cell gateway (e.g. femtocell gateway). The transformation of the parameters (e.g. the Markov-Parameters) into saturation probabilities may then be performed in the mobile radio cell gateway (e.g. the femtocell gateway) and the desired calculation power in the mobile radio cells (e.g. the femtocells) may be considerably reduced.

In other words, an example on the usage of the mechanisms introduced above with reference to FIG. 11A and FIG. 11B is as follows (based on the example that the decision making device (mobile radio base station selecting device) is in the mobile radio communication terminal device):

A) A mobile radio communication terminal device may be switched on in an area where multiple mobile radio base stations (in other words: multiple mobile radio cells), e.g. multiple femtocell base stations, are present, i.e. the mobile radio communication terminal device may have coverage from multiple mobile radio base stations (in other words: multiple mobile radio cells), e.g. multiple femtocells or femtocell base stations;

B) The mobile radio base stations (in other words: the mobile radio cells), e.g. the femtocells base stations, may have (already beforehand) calculated their usage characteristics based on a computational model, e.g. the Markov-model described above, and may be communicating these for example by secure broadcasting (alternatively, the mobile radio base stations (in other words: the mobile radio cells), e.g. the femtocell base stations, may be not broadcasting this information, but the mobile radio communication terminal device may have to request this information from each mobile radio base stations (in other words: from each mobile radio cell), e.g. from each femtocell base station;

C) The mobile radio communication terminal device may be waiting for the usage characteristics of all relevant mobile radio base stations (in other words: of all relevant mobile radio cells), e.g. of all relevant femtocell base stations;

D) Once the mobile radio communication terminal device has received all usage characteristics, it may calculate the preferred mobile radio base station (in other words: the preferred mobile radio cell), e.g. the preferred femtocell base station, to which it may go to establish a link;

E) The mobile radio communication terminal device may establish the link to the preferred mobile radio base station (in other words: the preferred mobile radio cell), e.g. the preferred femtocell base station.

In various embodiments, as described above, the mobile radio base station selecting device may select a mobile radio base station with which the radio communication terminal should connect. The decision may depend on parameters set by the user of the mobile radio communication terminal device, e.g. the amount of data that the user wishes to transmit and/or receive or the length of time the user whishes to communicate. These parameters may be transmitted to the mobile radio base station selecting device from the mobile radio communication terminal device upon the request of the information concerning the load situation at the respective mobile radio base station, or may be transmitted to the mobile radio base station selecting device in advance and may be stored in the mobile radio base station selecting device. These parameters may be set by the user for each connection request or may be predetermined values set for all connection requests.

Although in FIG. 9B, FIG. 10B, and FIG. 11B, communication is indicated with one mobile radio base station resp. mobile radio base station selecting device, communication could also be initiated with the other mobile radio base station resp. mobile radio base station selecting device.

In FIG. 9B, FIG. 10B, and FIG. 11B, data that is shown to be exchanged between to communication parties may be relayed by one or more other communication devices, e.g. by a respective gateway or by a mobile radio communication terminal device.

Although not shown with respect to FIGS. 9A to FIG. 11B, a load information collector may be provided for each mobile radio base station to collect the load information measured by a load measurement device. This information may be used to compute the usage characteristics of the respective mobile radio base station.

In various embodiments, the interactions between mobile radio communication terminal devices, mobile radio base stations (in other words: mobile radio cells), e.g. femtocell base stations, and the mobile radio communication network (e.g. (mobile radio cell) gateways, e.g. femtocell gateways) as well as operations to be performed in the decision making device (mobile radio base station selecting device) may be provided as described in detailed above.

In all scenarios shown in FIG. 9A to FIG. 11B, finally, the most suitable assignment of a radio communication terminal to a mobile radio base station (in other words: to a mobile radio cell), e.g. to a femtocell base station, may be used in order to establish a link.

The information required to determine the saturation probabilities of the mobile radio cells, e.g. of the femtocells, may be communicated to the relevant entities which are deciding on the link selection between the mobile radio communication network (e.g. the gateway) and the mobile radio communication terminal devices. This decision may be taken in the mobile radio communication network (e.g. in the gateway), in the mobile radio cell (in other words: in the mobile radio base stations; e.g. in the femtocell or femtocell base station) or in the mobile radio communication terminal device. While the derivation of the saturation probabilities of the mobile radio cells, e.g. of the femtocells, may be quite simplistic for the long term approach presented above, the derivation for the short term approach (as also detailed above) may lead to a more complex computational problem. Since a mobile radio cell (e.g. a femtocell) may be of limited calculation power, the saturation probability calculations may be performed for the long term approach directly within the mobile radio cell, e.g. the femtocell, due to its inherent simplicity. Then, the saturation probabilities may be directly forwarded to the decision making devices (mobile radio base station selecting devices) determining the link assignments between mobile radio cells, e.g. the femtocells, and mobile radio communication terminal devices.

For the short term approach, however, instead of the final saturation probabilities, rather the parameters, e.g. the Markov parameters (e.g., the (“bᵢ”, “dᵢ” and “aᵢ”) values for the various states as described above) may be communicated to the decision making device (mobile radio base station selecting device). This device is assumed to be capable of deriving the saturation probabilities based on the parameters (e.g. the Markov parameters, e.g. by performing a Monte-Carlo evaluation approach which may require several hundreds or thousands of iteration steps in the derivation process).

According to an embodiment, a mobile radio cell, e.g. a femtocell, may provide an interface that can either output i) the final saturation probability of the mobile radio cell, e.g. the femtocell (e.g. if the long term approach is chosen) or ii) the parameters, e.g. the Markov parameters, such that another system device may perform the derivation of the saturation probabilities (e.g. if the short term approach is chosen).

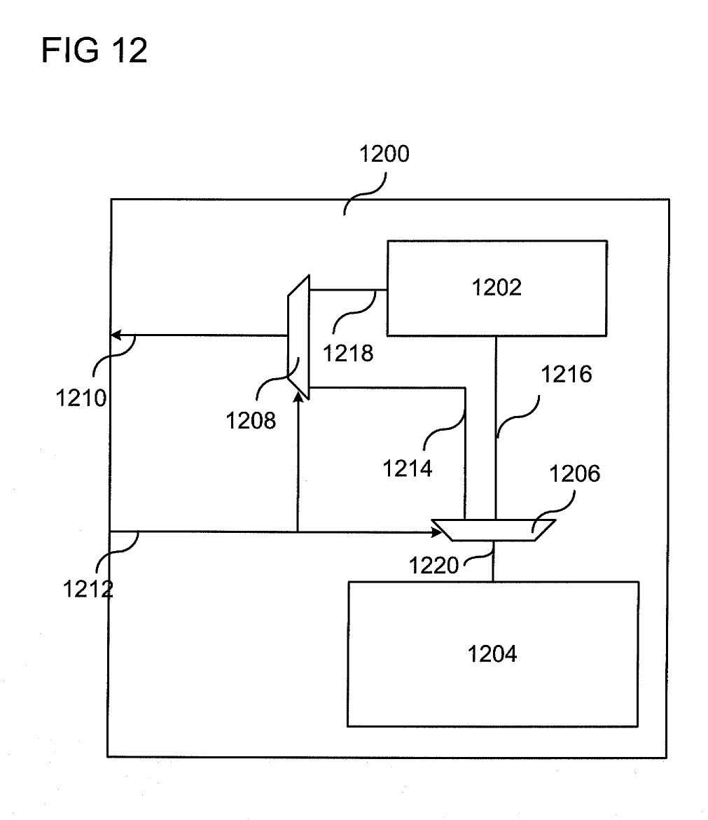

In various embodiments, the structure of the operations within a mobile radio base station (in other words: a mobile radio cell), e.g. a femtocell or femtocell base station, may be provided as represented in an illustrative way with reference to FIG. 12.

FIG. 12 shows a portion of a mobile radio communication system in accordance with an embodiment. Reference numeral 1200 designates a simplified representation of a mobile radio cell (e.g. a femtocell) with devices for deriving the usage characteristics and the long term approach based saturation probability.

Reference numeral 1202 indicates a device for deriving the long term approach based saturation probability of the mobile radio cell (in other words: of the mobile radio base station), e.g. of the femtocell base station. Reference numeral 1204 indicates a device for deriving the parameters (e.g. Markov parameters) related to the usage characteristics of the mobile radio cell (in other words: of the mobile radio base station), e.g. of the femtocell or femtocell base station. The relevant parameter estimates may be continuously updated during the operation of the cell (in other words: of the mobile radio base station), e.g. of the femtocell or femtocell base station.

Reference numeral 1210 indicates the output depending on the selection switch signal 1212. Either the long term approach based saturation probability of the mobile radio cell (in other words: of the mobile radio base station), e.g. the femtocell or femtocell base station, may be output or the parameters, e.g. the Markov parameters of the usage model of the mobile radio cell (in other words: of the mobile radio base station), e.g. of the femtocell or femtocell base station, may be output. The selection switch signal 1212 may be chosen by the mobile radio cell, and the mobile radio cell may set the switch signal 1212 to either output the long term approach based saturation probability of the mobile radio cell or the parameters, e.g. the Markov parameters, of the usage model of the mobile radio cell.

Reference numeral 1212 indicates the selection switch signal, and based on the selection switch signal 1212 the output type may be chosen: Either, the long term approach based saturation probability of the mobile radio cell (in other words: of the mobile radio base station), e.g. of the femtocell or femtocell base station, may be output, or the parameters, e.g. the Markov parameters of the usage model of the mobile radio cell (in other words: of the mobile radio base station), e.g. of the femtocell or femtocell base station, may be output.

In case that the selection switch signal 1212 is chosen so as to select that the parameters shall be transmitted, the switch 1206 may select to output the parameters, that are ouputted from the device 1204 on line 1220, to the line 1214, and furthermore the switch 1208 may select to output the parameters input to the switch on line 1214 to the output line 1210.

In case that the selection switch signal 1212 is chosen so as to select that the computed saturation probability shall be transmitted, the switch 1206 may select to output the parameters, that are ouputted from the device 1204 on line 1220, to the line 1216. The device 1202 may compute the saturation probabilities from the parameters input on line 1216, and may output the saturation probabilities on line 1218. The switch 1208 may select to output the saturation probabilities input to the switch on line 1218 to the output line 1210.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for establishing a communication connection for a radio communication terminal device in an area that is served by a plurality of base stations, the method comprising:
determining the load situation of each base station of the plurality of base stations;
selecting a base station out of the plurality of base stations depending on the load situation of each base station of the plurality of base stations; and
establishing a communication connection between the radio communication terminal device and the selected base station;
wherein determining the load situation of each base station of the plurality of base stations comprises evaluation of a computational model for the load situation of the respective base station.

2. The method of claim 1,
wherein each base station of the plurality of base stations is configured according to at least one radio communication technology of a radio communication technology family selected from a group of radio communication technology families consisting of:
a Short Range radio communication technology family;
a Metropolitan Area System radio communication technology family;
a Cellular Wide Area radio communication technology family;
a radio communication technology family which includes a radio communication technology in which the access to radio resources is provided in a random manner; and
a radio communication technology family which includes a radio communication technology in which the access to radio resources is provided in a centrally controlled manner

3. The method of claim 1,
wherein the load situation of each base station is determined based on at least one item selected from a group of items consisting of:
the level of usage of a at least one available resource of the base station selected from a group of resources consisting of a computational resource, a processor, a de hardware circuit, an application-specific integrated circuit, a field-programmable gate array, a software-defined radio circuit, a digital signal processor, a memory circuit, a radio interface circuit, a cable connection circuit, an asymmetric digital subscriber line circuit, a battery, an output power limitation circuit, a power budget circuit, and an antenna;
a number of connections at the respective base station;
an amount of data at least one of received at and transmitted from the respective base station;
a data rate of data reception at the respective base station;
a data rate of data transmission from the respective base station;
a data rate of data reception and data transmission at and from the respective base station;
a current load situation of the respective base station;
a load situation of the respective base station accumulated during pre-defined time intervals in the past;
a probability density function describing relation between the probability of saturation and the number of users of a base station;
a statistic optimization method optimizing parameters of parameterized functions for describing relation between the probability of saturation and the number of users of a base station;
a Maximum Likelihood type method estimating the relation between the probability of saturation and the number of users of a base station; and
a random walk type method estimating the relation between the probability of saturation and the number of users of a base station.

4. The method of claim 1,
wherein the computational model is a model selected from a group of models consisting of:
an adaptive model;
a static model;
a time variant model;
a Markov-type model;
an optimum filter;
a Kalman filter; and
a neural network type model.

5. The method of claim 1,
wherein the load situation of each base station is determined based on the current load situation of the respective base station accumulated during pre-defined time intervals, and wherein the load situation is determined based on the average load over the pre-defined time intervals.

6. The method of claim 1,
wherein the load situation is determined by evaluation of the computational model.

7. The method of claim 1,
wherein the computational model is evaluated to predict the load situation.

8. The method of claim 1,
wherein for each base station a load situation rating number quantifying the load situation of the respective base station is computed.

9. The method of claim 8,
wherein a load situation rating number is computed to quantify a pre-defined amount ofi data that can be received at the base station from the radio communication terminal so that during reception of the data the probability of saturation of the base station is below a predefined saturation probability.

10. The method of claim 8, further comprising:
for each base station collecting information about the load situation; and
acquiring the load situation rating number based on the collected information about the load situation.

11. The method of claim 10, further comprising:
measuring the load situation at predefined points of time.

12. The method of claim 1,
wherein the selection is performed repeatedly, and in case that the selected base station is different from the base station currently connected with the radio communication terminal establishing a radio communication connection between the radio communication terminal device and the selected base station.

13. A base station selecting device in a communication system comprising a plurality of base stations and a radio communication terminal in an area that is served by the plurality of base stations, the base station selecting device comprising:
a base station selecting device controller being configured
to determine the load situation of each base station of the plurality of base stations.
to select a base station out of the plurality of base stations depending on a load situation of each base station of the plurality of base stations; and
to trigger establishment of a communication connection between the radio communication terminal device and the selected base station; and
a model evaluator being configured to evaluate a computational model for the load situation of base stations for determining the load situation of each base station of the plurality of base stations.

14. The base station selecting device of claim 13,
wherein each base station of the plurality of base stations is configured according to at least one radio communication technology of a radio communication technology family selected from a group of radio communication technology families consisting of:
a Short Range radio communication technology family;
a Metropolitan Area System radio communication technology family;
a Cellular Wide Area radio communication technology family;
a radio communication technology family which includes a radio communication technology in which the access to radio resources is provided in a random manner; and
a radio communication technology family which includes a radio communication technology in which the access to radio resources is provided in a centrally controlled manner

15. The base station selecting device of claim 13,
wherein the base station selecting device controller is further configured to determine the load situation of each base station based on at least one item selected from a group of items consisting of:
the level of usage of a at least one available resource of the base station selected from a group of resources consisting of a computational resource, a processor, a dedicated hardware circuit, an application-specific integrated circuit, a field-programmable gate array, a software-defined radio circuit, a digital signal processor, a memory circuit, a radio interface circuit, a cable connection circuit, an asymmetric digital subscriber line circuit, a battery, an output power limitation circuit, a power budget circuit, and an antenna;
a number of connections at the respective base station;
an amount of data at least one of received at and transmitted from the respective base station;
a data rate of data reception at the respective base station;
a data rate of data transmission from the respective base station;
a data rate of data reception and data transmission at and from the respective base station;
a current load situation of the respective base station;
a load situation of the respective base station accumulated during pre-defined time intervals;
a probability density function describing relation between the probability of saturation and the number of users of a base station;
a statistic optimization method optimizing parameters of parameterized functions for describing relation between the probability of saturation and the number of users of a base station;
a Maximum Likelihood type method estimating the relation between the probability of saturation and the number of users of a base station; and
a random walk type method estimating the relation between the probability of saturation and the number of users of a base station.

16. The base station selecting device of claim 13,
wherein the computational model is a model selected from a group of models consisting of:
an adaptive model;
a static model;
a time variant model;
a Markov-type model;
an optimum filter;
a Kalman filter; and
a neural network type model.

17. The base station selecting device of claim 13,
wherein the base station selecting device controller is further configured
to determine the load situation of each base station based on the current load situation of the respective base station accumulated during pre-defined time intervals, and
to determine the load situation based on the average load over the time intervals.

18. The base station selecting device of claim 13,
wherein the base station selecting device controller is further configured to determine the load situation by evaluation of the computational model.

19. The base station selecting device of claim 13,
wherein the computational model is evaluated to predict the load situation.

20. The base station selecting device of claim 13,
wherein the base station selecting device controller is furrther configured to determine for each base station a load situation rating number quantifying the load situation of the respective base station.

21. The base station selecting device of claim 13, further comprising.
a measurement device configured to measure the load situation at predefined points of time.

22. The base station selecting device of claim 13,
further configured to be a part of one device selected from a group of devices consisting of:
at least one base station,
a radio communication terminal;
a gateway server;
a combination of at least one base station, a radio communication terminal, and a gateway server; and
a server external to the radio communication terminal and external to the network.

23. A method for selecting a radio base station out of a plurality of radio base stations serving a communication terminal for communication with the communication terminal, the method comprising:
selecting a radio base station out of the plurality of radio base stations based on a computational model for the load situation of at least one of the radio base stations.

24. A radio base station selecting device for selecting a radio base station out of a plurality of radio base stations serving a communication terminal for communication with the communication terminal, the radio base station selecting device comprising:
a radio base station selecting device controller configured to select a radio base station out of the plurality of radio base stations based on a computational model for the load situation of at least one of the radio base stations.

25. A method comprising:
evaluating a computational model for determining the load situation of a base station; and transmitting the determined load situation of the base station from the base station to a radio communication terminal device in an area that is served by the base station.
